(19) United States
(12) Patent Application Publication
(10) Pub. No.: US 2026/0000934 A1
(43) Pub. Date: Jan. 1, 2026

(54) SYSTEMS AND METHODS FOR DETERMINING ADHERANCE TO GAME STRATEGY

(71) Applicant: Adeia Guides Inc., San Jose, CA (US)

(72) Inventor: Serhad Doken, Bryn Mawr, PA (US)

(21) Appl. No.: 18/758,787

(22) Filed: Jun. 28, 2024

(51) Int. Cl. A63B 24/00

(52) U.S. Cl. CPC A63B 24/0006; A63B 24/0062; A63B 2024/0068

(57) ABSTRACT

Systems and methods are described for determining team formations, player performance relating to adherence to predetermined team formations, and coach performance during a live sports event. Methods include selectively obtaining and analyzing a video feed of the sports event to determine a player position with respect to field of play, another player from the same team, and/or a player from the opposing team. Methods divide the field into zones and identify predetermined formations (such as offense or defense formations) based on a current formation on the field of play. Distance differential vectors between current and identified locations/formations of a player or the team may be calculated, and used to determine if the player's current position on the field of play is aligned with an identified formation. If so, then one or more enriched user interface features may be provided, which include displaying current team formations and player statistics.

### FIELD OF DISCLOSURE

Embodiments of the present disclosure relate to analyzing video of a game to determine adherence of players to particular game strategy. Embodiments of the present disclosure also relate to evaluating coach performance, including performance relating to team formation strategy and swapping of players during the sports event. Embodiments of the present disclosure further relate to performing shape analysis of video of the sports event to determine a formation on a field of play and updating a user interface based on results of the shape analysis performed.

### BACKGROUND

Team sports such as soccer, basketball, American football, and ice hockey are popular not only in the United States but also in many parts of the world. Soccer, for instance, is a team sport played between two teams of 11 players each, who primarily use their feet to propel a ball around a rectangular field of play called a pitch. The objective of the game is to score more goals than the opposing team by moving the ball beyond the goal line into a rectangular-framed goal defended by the opposing team. Traditionally, the game has been played over two 45-minute halves, for a total match time of 90 minutes. With an estimated 250 million players active in over 200 countries and territories, it has become the world's most popular sport.

The strategy in a professional soccer match is all about setting goals and figuring out how to achieve them. For example, a coach might have specific ideas about how they want their team to attack or defend during a game. To make that happen, the coach may hold training sessions and meetings with the team's leaders and the coaching teams. The coach may discuss designed plays, formations, and other game strategies with the players. That way, all the players are on the same page and ready to execute a designed play or a formation as and when needed in the game.

One drawback, however, with the current methods is that it is quite hard for a coach, even with their assistants, to spot in real time how well the team is sticking with the set-out strategy (either set at the beginning of the game or changed during halftime or at any time during the game), and to identify problems since there are 11 players always moving around on the field in addition to the desire to track the opponent team's players. Players may know what their duty is at times during the game, given to them by the coach, but in the heat of the moment, they may forget the instructed formation role they have and act instead on intuition.

Yet another drawback with the current methods is the difficulty of keeping track of which formations the team is deploying and whether the players are sticking to those formations. For example, as the game progresses and the players move from location to location, they may form new formations that are hard for the coach to see or determine in real time. Not knowing which formation the team is playing at any given moment, the coach may not be equipped with the knowledge to design plays on the fly that are effective based on a current formation.

Some current methods present a game on a user interface and provide statistics related to players in the game. Such methods, although are useful for reviewing player statistics, are not interactive and users typically either loose interest due to lack of their interactive participation in the game or just end up watching some other channel or content during lulls in the game.

As such, there is a need for a system and method that provides a technical solution for identifying the strategy that is being executed versus the strategy that has been conceived and instructed, and alerting or identifying the coach and others of the formation that is being executed by the team, and keeping the user engaged and interactive in the game.

### BRIEF DESCRIPTION OF THE DRAWINGS

The present disclosure, in accordance with one or more various embodiments, is described in detail with reference to the following figures. The drawings are provided for purposes of illustration only and merely depict example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale. The various objects and advantages of the disclosure will be apparent upon consideration of the following detailed description, taken in conjunction with the accompanying drawings, in which like reference characters refer to like parts throughout, and in which:

FIG. 1 is a block diagram of a process for determining player performance, player adherence to game strategy, and team formation, in accordance with some embodiments of the disclosure;

FIG. 2 is a block diagram of an example system in accordance with some embodiments of the disclosure;

FIG. 3 is a block diagram of a user device in accordance with some embodiments of the disclosure;

FIG. 4 is a flowchart of a process for displaying game statistics and providing player-related suggestions, in accordance with some embodiments of the disclosure;

FIG. 5 depicts examples of types of sports or events to which embodiments described herein may be applied, in accordance with some embodiments of the disclosure;

FIG. 6 depicts examples of different fields of play that are divided into a plurality of zones, in accordance with some embodiments of the disclosure;

FIG. 7 is an example of an offensive formation in a soccer game that depicts locations of players in different zones, in accordance with some embodiments of the disclosure;

FIG. 8A is an example of table of a plurality of formations in a soccer game, in accordance with some embodiments of the disclosure;

FIG. 8B is an example of table of a plurality of formations in an American football game, in accordance with some embodiments of the disclosure;

FIG. 9 is a block diagram of players' names, their jersey numbers, and play positions for a first and a second team, in accordance with some embodiments of the disclosure;

FIG. 10 is an example of a matrix of distance differentials for each player being monitored, in accordance with some embodiments of the disclosure;

FIG. 11 is an example of visually displaying the distance differentials for each player being monitored, in accordance with some embodiments of the disclosure;

FIG. 12 is a table of player statistics, in accordance with some embodiments of the disclosure;

FIG. 13 is a bell curve that displays team effectiveness of formations used by a team during a game, in accordance with some embodiments of the disclosure;

FIG. 14 is an example of one or more players in a soccer game not playing in their identified offense location, in accordance with some embodiments of the disclosure;

FIG. 15 is an example of a defending team formation line having been breached by the attacking team due to one of the defending players not sticking to the identified position or formation they have been given, in accordance with some embodiments of the disclosure; and

FIG. 16 is a flowchart of communication processes between components of a system for performing various player and team suggestions, and providing a betting platform, in accordance with some embodiments of the disclosure.

### DETAILED DESCRIPTION

Embodiments disclosed herein help to address the above-mentioned limitations by detecting formations of a team during a live game/sports event, such as by performing shape analysis or based on player locations and coordinates; detecting changes in a formation; detecting forming of an upcoming formation based on player movement on the field of play; determining whether a player, a group of players, or the team as a whole is adhering to a predetermined formation (also referred to as identified formation); determining whether a player's current location adheres to a predetermined location that is predetermined for the player to be in formation with the rest of the team; and determining how closely a player follows game strategy by sticking to a predetermined formation.

Some of the above-mentioned limitations are also addressed by determining a distance differential between a player's current location and one or more of a) coordinates on a field of play, b) another player from the same team or c) another player from an opposing team, and taking action based on the determined distance differential. The actions may include associating positive score or ratings, which may include positive points, fantasy points, etc., with a player being within the distance threshold, associating negative score or ratings, which may include negative points, fantasy points, etc., with a player being outside the distance threshold, and providing alerts to a coaching team informing them of the distance differentials.

Some of the above-mentioned limitations are also addressed by determining whether a current formation is an offense or defense formation; detecting change from offense to defense or defense to offense formation as they occur; providing alerts to coaches, fans, and others on the user interfaces of their electronic devices; and providing data and displays relating to formations on the field and updating them based on changes in formations on the field of play and adherence of players to the predetermined/identified locations and formations.

Some of the above-mentioned limitations are also addressed by detecting breaches of formations by players, including players that are currently playing offense or defense; analyzing the breach and surrounding circumstances; alerting a coaching team of the breach; determining whether an exception to the breach applies; and reflecting the player's statistics based on nature of breach and any exceptions.

Some of the above-mentioned limitations are also addressed by evaluating player performance and swapping of players based on their performance. Fans may also vote on swapping and substitution of players, including voting on substitution-related items, such as should the player on the field have been substituted, was the substitution made at the right juncture of the game, is the player that substituted the player on the field an appropriate fit based on the current stage of the game and the current team formation, did the coach substitute too early or too late, etc.

In some embodiments, during a live game, such as a basketball, soccer, or an American football game, a plurality of live video feeds is received. A selection of a single live video feed (or multiple feeds) from the plurality of live video feeds is made. The selection may be based on determining which player or which team is to be monitored. Since the plurality of cameras that provide the live video feed span the field of play in different locations and directions, the selected live video feed may be targeted at a particular zone on the field of play, such as the midfield in a soccer game; or where the action is currently taking place, such as the ball being near a goal; or at a specific player or the team, to monitor the player, team, or action taking place. As such, a video feed that displays the desired action, location of the field, or player of interest may be selected.

A coach, or a coaching team, typically designs plays in which a player, a group of players, or the whole team are to be at certain locations on the field at a certain stage of the game. A designed play may also require the player, a group of players, or the whole team to be in a certain formation based on their locations on the field of play, such as a 3-4-3, 4-3-3, 3-5-2 for a soccer match when the team is midfield, triangle offense in a basketball game, 4-3 defense formation in American football, etc. These formations may require a player, a group of players, or the team to occupy certain locations on the field, such as particular zones, maintain certain distances and positions from players of the same team, or maintain certain distances and positions to guard players from the opposing team. The formations may also be based on which player has the ball, for example, if a particular player typically plays offense, or has an offense position, then if the player has the ball a determination may be made that the team is currently playing offense.

To be able to track the players based on location on the field with respect to another player from the same or the opposing team, in some embodiments, the field of play may be divided into a plurality of zones. These zones may be “virtual” zones that may be visible and displayed only on a user interface of an electronic device. Dividing a field of play into zones may allow location tracking of a player or team with respect to the zone, e.g., with respect to a location on the field, to determine whether the player or team are in zones as planned according to game strategy. It may also allow tracking the player with respect to another player from the same team or the opposing team. For example, based on a zone assigned to a player, a determination may be made whether player 1 is in the same zone as player 2, in order to be in line with a predetermined soccer formation. In another embodiment, shape analysis may be performed based on the video frames of the selected video feed to determine player and team locations on the field of play and be used to determine whether the player or team are adhering to a predetermined, i.e., preassigned, or identified location on the field of play.

Once the field of play is divided into a plurality of zones, or a shape analysis is performed, and a determination of a current location of a player, group of players, or team is made, in some embodiments, a predetermined formation that is associated with the current location may be accessed. For example, based on location of the player, group of players, or team, or based on shape analysis, a determination is made that, for example, the team of interest is currently playing offense and currently located in the midfield of a soccer game, then an identified offense formation for a midfield for the team of interest may be accessed. A comparison may be made between a predetermined location or formation and current location or formation for a player, group of players, or team.

In some embodiments, the comparison between a predetermined location or formation and a current location or formation may be made using a plurality of techniques. One such technique may include generating a matrix for a predetermined location and a second matrix for a current location for each player, group of players, or team. The matrices may then be compared to calculate a vector that represents a distance differential of where a player is predetermined to be located and where the player is currently located. Another such technique may include overlaying on a user interface a graphical representation of a predetermined location and comparing it to a current location of the player, group of players, or team. A vector may be displayed graphically that represents a distance differential of where a player is predetermined to be located and where the player is currently located.

The distance differential may be calculated for a current location versus a predetermined location with the respect to the field of play or with respect to another player on the same team or the opposing team. If a determination is made that a player exceeds a distance threshold from where the player is predetermined to be, then a second determination may be made whether an exception applies for the player to exceed the distance threshold. Some exceptions may include the player advancing the ball, running at a particular pace with the ball, being defended vigorously or in close proximity with a player from the opposing team, being in a scoring position, or breaching or violating their position or the distance threshold only for a period of time that is within a threshold time period. If the exception applies, the player may be associated with positive score or ratings and if the exception does not apply the player may be associated with negative score or ratings.

Other embodiments disclosed include measuring and displaying performance of the player or performance of the coach. They also include predicting a formation as the play continues, providing betting opportunities to fans based on statistics relating to performance of the player and the coach, or awarding fantasy score, ratings, or points to a player, team, and/or coach. Yet more embodiments disclosed include providing notifications on a user interface for substituting a player, providing recommendations for substituting a player (e.g., including which player to use for the substitution), measuring a coach's performance when it relates to substitution of a player, and scoring the coach based on the substitutions made.

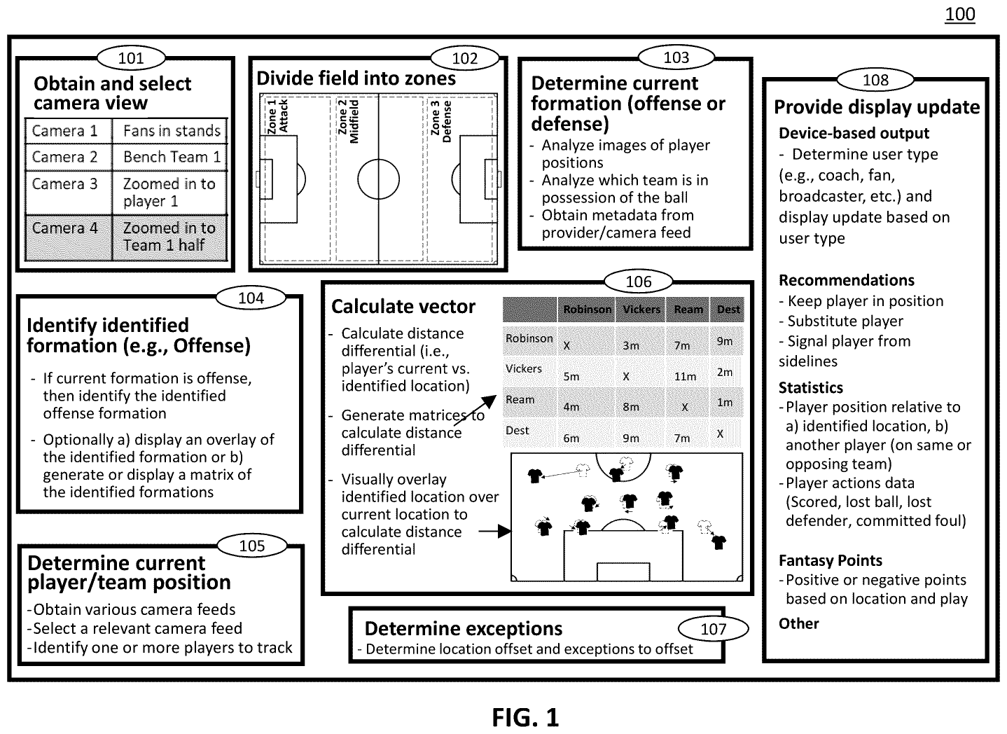

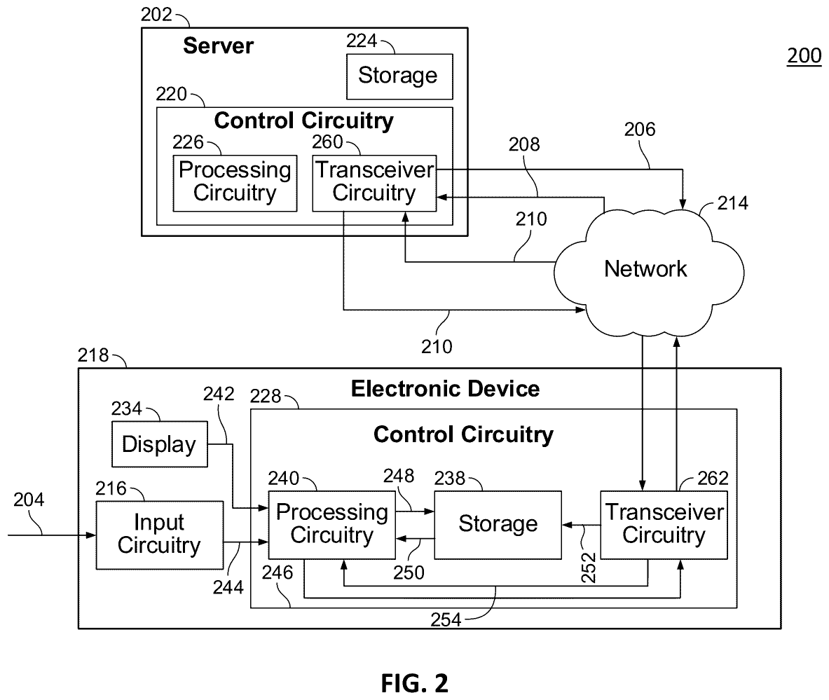

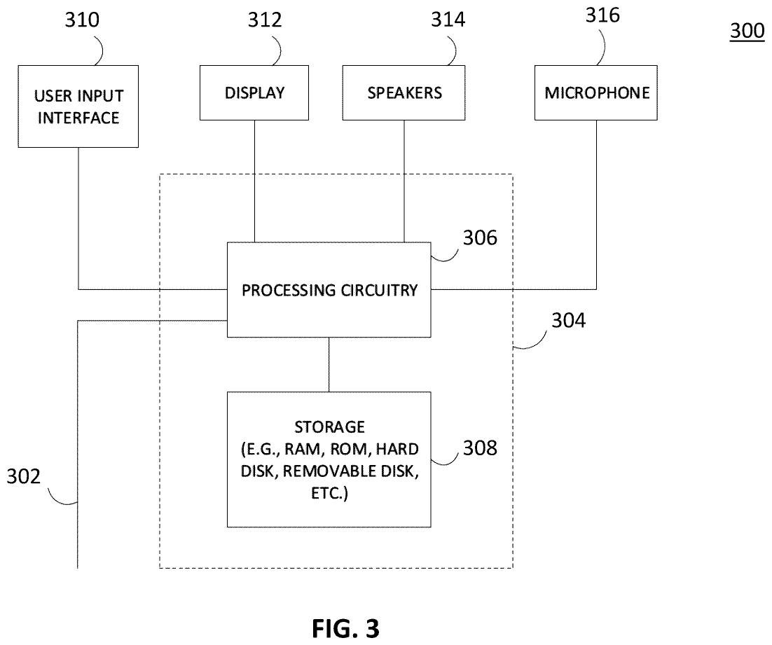

Turning to the figures, FIG. 1 is a block diagram of a process 100 for determining player performance, player adherence to game strategy, and team formation, in accordance with some embodiments of the disclosure. The process 100 may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

In some embodiments, at block 101, control circuitry, such as the control circuitry 200 and/or 228 of system 200 of FIG. 2, may receive multiple live camera feeds/streams from a live game/sports event. In some instances, the field of play, such as an American football field or a soccer field, which covers a large area, may have several cameras capturing the live action on the field as well as providing footage of fans in the stadium and surroundings of the stadium, including an aerial view of the stadium. As depicted in block 101, in one example, camera 1 may be transmitting video of the fans in the stands; camera 2 may be transmitting video of the bench, such as the home team's or the away team's bench, dugout, etc.; camera 3 may be transmitting zoomed-in video of a specific player, such as player 1; and camera 4 may be transmitting zoomed-in video of a portion of the field of play, such as Team 1's half of the field in a soccer game. In some embodiments, the control circuitry 200 and/or 228 may analyze video feeds from multiple cameras and select a video feed of interest, such as a video feed of the widest-angle view of the field, a specific player, a specific portion of the field of play, where the game action is taking place, etc. In some embodiments, the control circuitry 200 and/or 228 may format the received video stream from a selected camera in landscape mode, which means the x axis is the length of the field and the y axis is the width of the field. The control circuitry 200 and/or 228 may then, depending on the camera zoom and angle, normalize the computed [x, y] coordinates of the field of play to the normal size of the field. Such normalization would allow the control circuitry 200 and/or 228 to display the field on a display of an electronic device, such as on its user interface, in a size that proportionately reflects the actual field. In some embodiments, each camera feed may be analyzed to cover the entire field of play. In another embodiment, camera feed which covers the entire feed may be analyzed either by itself or in conjunction with a specific camera field focused on a zone or a player such that, for example, both a focused and a larger-scale view and perspective of the player's position may be determined.

In some embodiments, supplemental content related to the player, the team, or the formations, may be provided on the same broadcast feed on which the user is consuming the game or over a separate broadcast feed. In yet other embodiments, supplemental content related to the player, the team, or the formations, may be provided on the same user interface or device on which the user is consuming the game or on a separate user interface or user device. Supplemental content may be any content related to the player, the team, formations, game strategy, fantasy game in which a player currently playing is included, etc.

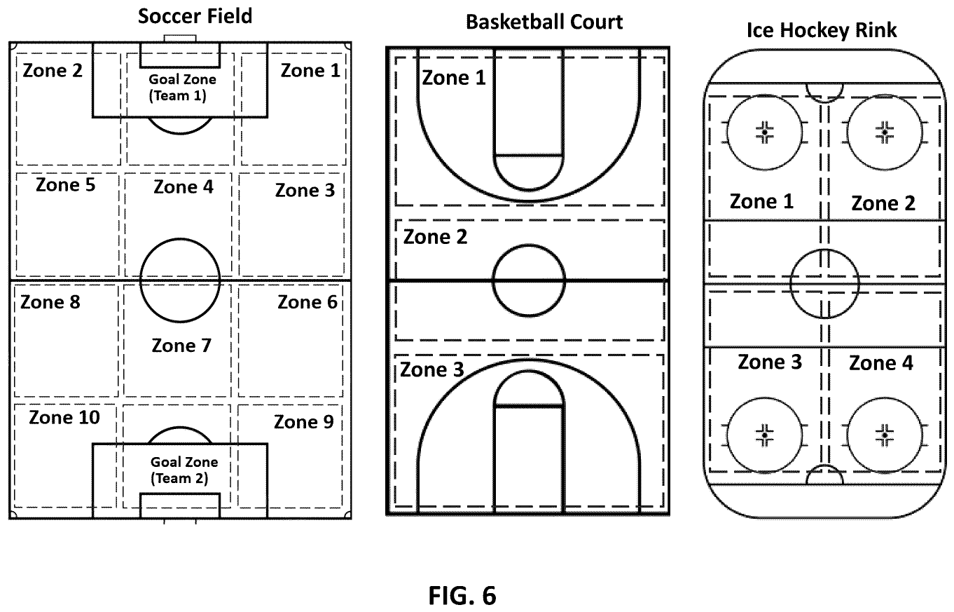

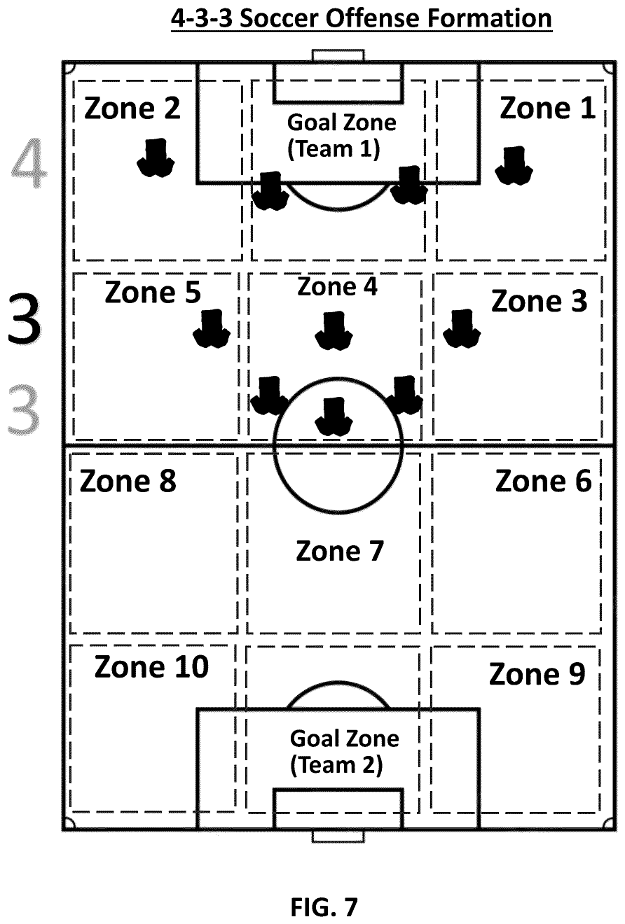

At block 102, the control circuitry 200 and/or 228 may divide the field of play into a plurality of zones, such as three zones that are attack zone 1, midfield zone 2, and defense zone 3. Since the fields of play in soccer, American or Canadian football, rugby, basketball, lacrosse, handball, field hockey, ice hockey, volleyball, cricket, water polo, polo, baseball (and field of play of other sports events) may differ from one another, the control circuitry 200 and/or 228, in one embodiment, may divide the field of play into zones based on the amount of area to be covered. For example, in some embodiments, a greater number of zones may be generated to cover a larger field of play and lesser number of zones to covers a smaller field of play. Additional examples of zones are depicted at FIGS. 6-7.

In some embodiments, instead of dividing the field of play by area, the control circuitry 200 and/or 228 may divide the field of play based other factors. These factors may be used to determine both the number of zones and the area and coverage of each zone. These factors may include coverage of key portions of the play, such as the three-point line and inside the paint for a basketball game; the end zones in American football, or perhaps the last 10 yards before the end zones; the penalty area or a corner area in a soccer game, etc.

Yet another factor for determining the number of zones or the coverage of a zone may be the style of play or types of formations on the field. For example, on a soccer field, the offense formation may include a 4-3-3 formation that uses four defenders—made up of two center-backs and two full-backs—behind a midfield line of three. The most common setup in midfield in this formation may be one deeper player—the single pivot—and two slightly more advanced to either side. The front line may then be composed of two wide attackers who play on either side of a single center-forward. Since one of the goals is to ensure that players are sticking to their formations and positions, in such a scenario, e.g., a 4-3-3 formation in a soccer game, the control circuitry 200 and/or 228 may divide the field of play in a manner such that each of the 4, 3, 3 (or each position) is associated with a zone. The zones may be granular and focused, or wide. The zones may be used, as will be described in further detail below, by the control circuitry 200 and/or 228 to determine whether the players in the 4-3-3 formation are sticking to their formation as the game progresses. As such, generating a zone where the player is anticipated to be, based on the player position and the formation, may be helpful in tracking and determining whether the player is in the zone as anticipated.

The control circuitry 200 and/or 228 may display the zones as a virtual outline on a user interface of an electronic device. The zones may be provided as an overlay on the video display of the live game on the user interface. The zones may also appear and disappear over time on the user interface such that they are not displayed at all times causing a distraction to the users. The control circuitry 200 and/or 228 may also allow the users of the electronic device to turn on/off the zones as desired. In another embodiment, the zones may not be displayed by the control circuitry 200 and/or 228 for performing back-end processing of player and team positions, formations, etc. The electronic device may be a device used by a coach or a device used by a fan to monitor the game. The electronic device may also be used by a broadcaster or a person analyzing the statistics of the game. The control circuitry 200 and/or 228 may cause to display a different type of user interface on each such electronic device, or a same type of user interface, however with different displays on the user interface based on the intended use. For example, if the electronic device is a coaching device, the control circuitry 200 and/or 228 may display various game plays that are private and confidential to the team that cannot be shared publicly, player performance details, swap suggestions, and other coaching-related features. In another embodiment, if the electronic device is associated with a fan, such as their smartphone or tablet, then the display may include information, player analysis, formation, etc., that is generated by the control circuitry 200 and/or 228 and can be publicly shared.

At block 103, the control circuitry 200 and/or 228 may determine whether the current formation in a field of play by a selected team is an offense or a defense formation. Analogy and references will be made to a soccer game to provide context of how the control circuitry 200 and/or 228 makes the offense/defense determinations. Although analogy and references are made to a soccer game, the embodiments are not so limited and any multiplayer game, including a video game, with two teams with a first team having at least one player and a second team having a plurality of players on a field of play that is real or virtual, is contemplated within the embodiments.

To determine whether the current formation in a field of play for a selected team is an offense or a defense formation, the control circuitry 200 and/or 228 may analyze video and current images of player locations on the field of play, analyze which team is in possession of the ball, or obtain metadata from the provider or the video stream that indicates which team is currently in possession of the ball or playing offense or defense. For example, in a typical broadcast of a game on television, the service provider or the broadcasting company that is providing the footage of the game may indicate which player or team has possession of the ball (e.g., San Francisco 49er's on their third down at the 40-yard line). In another example, such as in a basketball game, the control circuitry 200 and/or 228 may analyze current player locations to determine whether the team is on offense or defense. For example, if a basketball game between the Golden State Warriors and the Los Angeles Lakers is being played, and both the teams are in the half side of the court which is dedicated for the Warriors to score a basket, then the control circuitry 200 and/or 228 analyzing player positions may determine the Golden State Warriors are on offense and the Los Angeles Lakers are on defense. The control circuitry 200 and/or 228 may also analyze the orientation of the players to determine whether the team is on offense or defense. For example, if all the players associated with the Los Angeles Lakers are oriented such that they are facing away from the basket, then the control circuitry 200 and/or 228 may determine that because the players associated with the Los Angeles Lakers are facing away from the basket, they are likely defending their basket and guarding players from the Golden State Warriors. As such, based on the orientation, the control circuitry 200 and/or 228 may determine that the Golden State Warriors are currently in an offense formation and the Los Angeles Lakers are currently in a defense formation.

In yet another embodiment, in order to determine whether a team is playing offense or defense, the control circuitry 200 and/or 228 may ingest data sets involving player rosters and their jersey numbers, split the team into different subsets with players having specific roles on offense or defense, split the field of play into respective sets, e.g., offense and defense, compute the relative positions of the team players with respect to other players on the same team and opposing team and with respect to field of play, compute specific field coordinates (x and y) in the video frames containing these players, cluster players based on their locations on the field of play, generate matrices of their locations, and determine whether a player is on offense or defense and also determine, based on the offense or defense formation, if a specific player is within a location that is anticipated in the offense or defense formation. Such process steps may be interchanged and not specifically performed in any particular order and are described in further detail below.

In some embodiments, using the above-mentioned process, the control circuitry 200 and/or 228 may determine team formation strategy in real time as the play progresses. Since play changes second by second, e.g., a team that is on the offense may suddenly be playing defense if the opposing team takes control of the ball. The offense and defense formations can change by the second and such changes in offense and defense and the new formations are determined by the control circuitry 200 and/or 228 using the processes described herein.

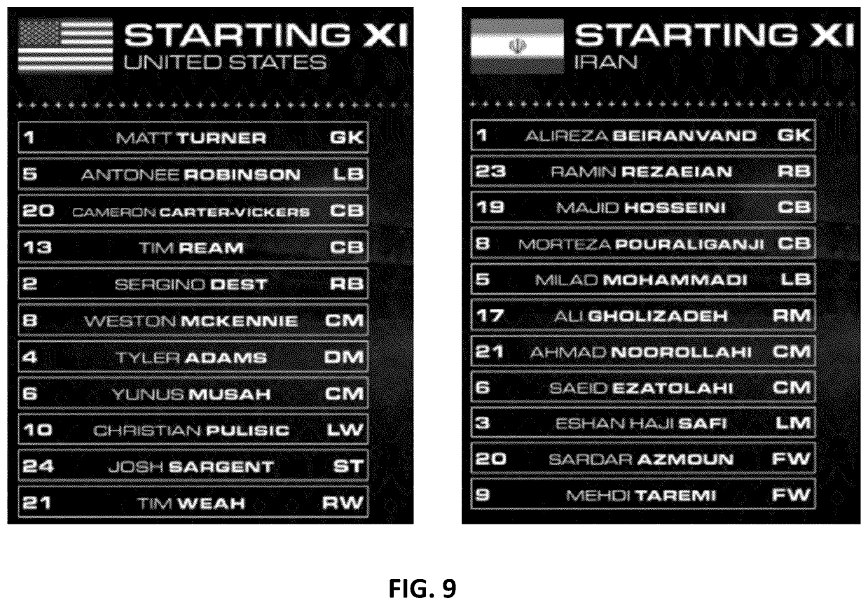

In some embodiments, the control circuitry 200 and/or 228 may obtain an input roster of both teams playing on the field of play. The rosters may be published prior to the game and may also indicate the assumed positions of the players. One example of such a roster is provided in FIG. 9 below, where United States soccer team played the Iranian soccer team for the 2022 World Cup. The inputted data may also include associated jersey numbers for each player. For example, as depicted in FIG. 9, player Yunus Musah from the United States as a jersey number 6, Josh Sargent has a jersey number 24 and Iranian player Ramin Rezaeian has a jersey number 23.

The control circuitry 200 and/or 228, using selected video from the various camera feeds, may then track these players within the video frames based on the jersey numbers. It may also leverage existing computer vision (CV)/machine learning (ML) algorithms/code and trained models available in the industry, such as Kaggle™, to perform player tracking. In certain circumstances, when tracking by jersey number is not available or as an alternative to tracking using jersey numbers, the control circuitry 200 and/or 228 may track a player using facial recognition, player height, player physique, etc. The tracking may be performed respective to the player's playing position. For example, if a player plays a forward attacker position, which is expected to be in the final one third of the field (e.g., the “attack zone 1” of block 102), then the control circuitry 200 and/or 228 may track the player on the field of play around the final one third of the field.

In some embodiments, the control circuitry 200 and/or 228 may start with the empty field of play as a base data set, which may be obtained from the video frames before the game has started or from a separate data source that has the field size information. The control circuitry 200 and/or 228 may then split the field into respective sets, such as three respective sets as depicted in block 102 where the defenders are expected to be in the first third of the field for their team, midfielders in the second third (midfield) of the field and forward attackers are expected to be in the final third of the field. Although three sets are described, the embodiments are not so limited, and any combination or number of sets may be used.

In some embodiments, using the example roster information of FIG. 9, as a next step, the control circuitry 200 and/or 228 may compute the relative positions of the team USA players with respect to each other. In order to determine which strategy is being implemented, the control circuitry 200 and/or 228 may divide the Team USA players into five different sets such as the following (jersey numbers and assumed positions):
Set 1: (5, LB) (20, CB) (13, CB)
Set 2: (2, RB)
Set 3: (8, CM) (4, DM) (6, CM)
Set 4: (10, LW)
Set 5: (24, ST) (21, RW)

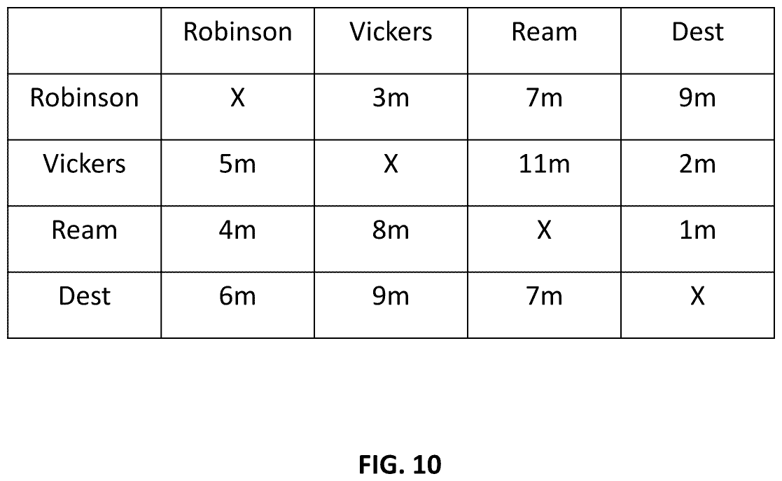

The five sets described illustratively used as a starting set. Any other combination of sets and configuration of players in the set may be used. The control circuitry 200 and/or 228 may use these sets to determine whether the players are fitting into one formation versus another, e.g., an offense formation or defense formation, and specifically what type of formation even within the offense or defense formation. In that regard, the control circuitry 200 and/or 228 may compute specific field coordinates (x and y) in the video frames of these players that are in these base sets and the distance between their coordinates with respect to each other. The control circuitry 200 and/or 228 may also determine whether the formation is an offense or defense formation based on who is controlling the ball and the direction of the movement of the ball. For example, if a particular player typically plays offense, or has an offense position, and is currently in possession of the ball, then a determination may be made that the team is currently playing offense. Likewise, if a particular player typically plays defense and is guarding another player who has the ball, then a determination may be made that the team is playing defense. The control circuitry 200 and/or 228 may then average the data collected from the frames and record it periodically, such as every second (30 frames). To perform the computation, in one embodiment, the control circuitry 200 and/or 228 may generate several matrices for each set with each player showing up in the columns and rows of the matrix, such as the matrix depicted in FIG. 10. In another embodiment, the control circuitry 200 and/or 228 may generate a single matrix, instead of several matrices, and the single matrix may include distance values or distance vectors of each player with respect to the others.

In some embodiments, when the Set 1 players are detected to be close to each other (e.g., players (5, LB) (20, CB) (13, CB) in the example above), the control circuitry 200 and/or 228 may keep them in that existing set. However, when the RB player with the jersey #2 is computed to be closer to Set 1 players versus Set 3 players, the control circuitry 200 and/or 228 may add the player to Set 1 (or vice versa). Since the players constantly change locations on the field of play, the changes form set to set and addition and removal of players from a set may be an iterative process as the game progresses. In some embodiments, the control circuitry 200 and/or 228 may detect patterns emerging using a computed mean average in terms of which sets certain players belong to and how that translates into a particular formation. For example, if certain players more often line up in a foursome formation, then the control circuitry 200 and/or 228 may detect them as a pattern of the 4-3-3 soccer formation and determine that the team is currency playing offense, and more particularly the 4-3-3 offense formation.

Once the current formation of the team is determined at block 103, at block 104, in one embodiment, an offense or defense formation that correlates with the current state of the game may be identified. In other words, if a determination is made at block 103 that the team is within an identified (also referred to as predetermined) distance of a 3-4-3 formation, then a 3-4-3 formation may be identified. In another embodiment, if a determination is made at block 103 that players of the team are in certain zones, then a formation most applicable based on the players being in the certain zones may be identified. The identified formation is a formation that is according to the game plan that is to be executed at a particular time or stage in the game. For example, a soccer coach may have designed a play in which a team on offense, marching towards the opposing team's half of the field of play and getting closer to the opposing team's goal, needs to be in a 3-4-3 formation to go on the attack in an attempt to score a goal. Such 3-4-3 identified formation may place each player in a particular area of the field of play, or more specifically in a zone, such as the zones depicted in block 102.

In one embodiment, the identified formation may be identified and used on the back end by the control circuitry 200 and/or 228 to perform additional processing. In another embodiment, the control circuitry 200 and/or 228 may display an overlay of the identified formation on top of a video that shows the current positions of the players.

At block 105, the control circuitry 200 and/or 228 may obtain various camera feeds and select a relevant camera feed for tracking the team or a specific player.

At block 106, the control circuitry 200 and/or 228 may compare an identified location of a player and/or the team, based on the identified formation identified at block 104, with a current location of the player and/or the team, based on the current position obtained at block 105, to determine whether the player and/or the team is following the identified formation or deviating from it.

In one embodiment, the comparison between identified location and current location (i.e., data from blocks 104 and 105) may be performed on the back end, and a distance vector may be calculated from the identified location of a player (which is based on an identified formation) to the player's current position. In another embodiment, a matrix for the current location of the player and a matrix for the identified location of the player may be generated and compared to calculate the distance vector. In yet another embodiment, the identified location of the player and/or the team may be overlayed on the live video of the game on a user interface. A vector may then be displayed graphically from the identified location of the player to the current location of the player.

The vector calculated, in some embodiments, may represent the distance from an identified location of the player to the current location of the player. Since the location of the players change constantly over the duration of the game, the vectors may be continuously updated to show where the player should be located, based on the identified formation according to a designed game strategy or based on coach-assigned and video-analysis-detected team formation, and where the player is actually located. The vector values may be used in determining how well and how closely the player follows the coaching strategy or sticks to standard or identified formations.

In some embodiments, the vector calculated, as described above, is from a predetermined (also referred to as identified) location to a current location (or vice versa). In this embodiment, the control circuitry 200 and/or 228 may identify the predetermined location with respect to a zone, such as a zone depicted in block 102. As such, in one example, if a team has advanced to the opposing team's half, and the predetermined formation places a first player in zone 2, then the vector may be determined from zone 2 to the current location of the first player.

In other embodiments, rather than using a zone as a predetermined location to calculate the vector, another player from the same team may be used to calculate the vector. In other words, the anchor or the origin for the vector may be another player rather than a location on the field of play. In these embodiments, as displayed in the matrix at block 106, player Robinson's location may be determined with respect to player Vickers, which in this example is three meters. If the predetermined formation requires that Robinson be within four meters of Vickers in a 4-3-3 formation, the vector may be calculated from Vickers to Robinson to determine if Robinson is following the predetermined formation. Since Robinson seems to be three meters from Vickers, e.g., within the four-meter threshold provided by the predetermined formation, Robinson may be determined to be following the predetermined formation. On the other hand, in an example where the same rule applies to Vickers and Ream, where Vickers is required to be within four meters of Ream according to the predetermined formation, the vector may be calculated from Vickers to Ream, or Ream to Vickers, to determine whether Vickers and Ream are staying within their predetermined distance of each other. Since Vickers is 11 meters away from Ream, e.g., exceeding the four meters' distance allowed by the predetermined formation, the control circuitry 200 and/or 228 may determine that either Vickers or Ream has violated the rule of staying within four meters of each other.

In some embodiments, the vector calculations may be used in determining whether a player has breached, e.g., not followed game strategy to be in a position/location where they were designated to be according to a game plan. In some embodiments, a player may breach the predetermined formation whether the player is on defense or offense. Some examples of breach when the player is on the offense include being in a zone other than the predetermined zone at a certain stage of play; exceeding the threshold distance from the predetermined location in a zone; not aligning with other players to follow a predetermined formation, such as not being part of the 4-3-3 formation when the rest of the team is in that formation; and exceeding the predetermined distance from another player from the same team. Some examples of breach when the player is on the defense include not guarding the opposing player within a threshold distance, not being in a predetermined zone at a certain stage of play (e.g., in basketball when zone defense is played), exceeding the threshold distance from the predetermined location in a zone that the player is predetermined to guard, and allowing an opposing player to breach a defense formation line.

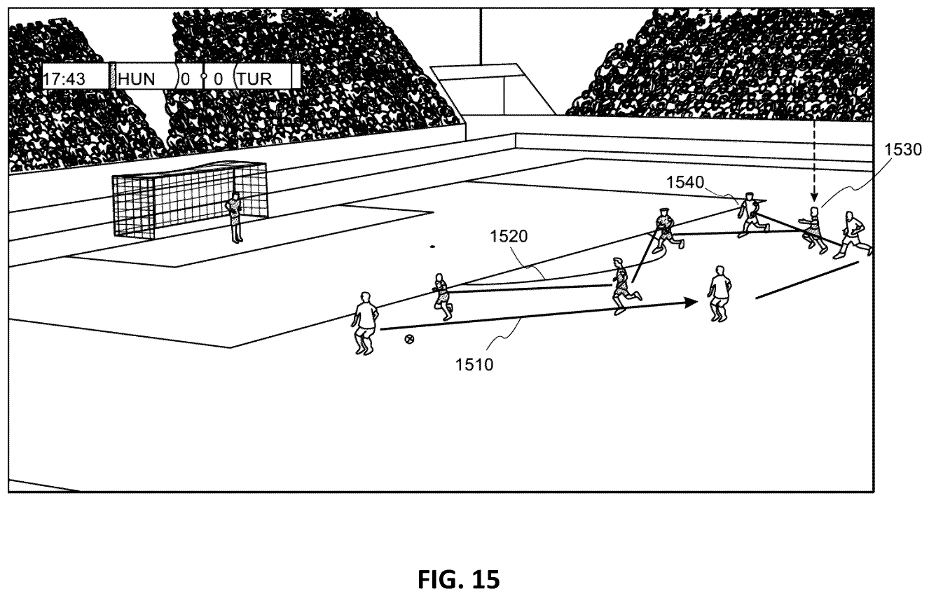

When a player breaches, various breach-related actions may be executed by the control circuitry 200 and/or 228. For example, the control circuitry 200 and/or 228 may highlight the player that has breached, assign a higher coefficient to the player's metrics while computing their formation adherence, present substitution options for the breaching player to the coach and allow fans to vote on the substitution. For example, in FIG. 15, while the defending team is adhering to the defense four formation, a specific player may have let the opposing team breach the formation (blue lines crossed the red lines of the defending four formation). In other words, the specific player may have not defended the opposing player well enough and let the opposing player pass by him/her and in a position to score a goal in a soccer game. In this case, causing a breach of the formation may have a higher coefficient versus being close to an opposing team player which means guarding situations because the breach may have caused the opposing team to be in a position to score a goal. Since the player has breached and not provided good defense, the player may be placed on the probation list and their metrics may be computed for a potential replacement.

In another embodiment, as described above, a breach may occur when a player violates a formation. This may be due to the player exceeding a distance from their desired position (e.g., from a desired zone or from another player). When such a breach of formation occurs, a higher coefficient may be assigned to this player's metrics while computing their formation adherence stats.

In some embodiments, once a breach of a detected formation happens frequently enough, over a threshold (e.g., more than 30% of the time that the formation has been in effect), further recommendation may be sent to the coach about a different formation. For instance, once the computation detects that while a 4-3-3 formation has a lot of breaches in the midfield (from multiple players in that midfield formation), a new formation such as a 4-4-2 may be suggested as an alternative formation. In such a case, formation breach calculation may be computed based on the defense-midfield-forward subsets.

In some embodiments, the control circuitry 200 and/or 228 may record details related to the breach. For example, the control circuitry 200 and/or 228 may record, when the formation breaches are happening, which player is causing the breach, what game circumstances surround the occurrence of the breach, which opposing player is forcing the breach to occur, which portion of the field is the breach occurring more commonly in, etc.

In some embodiments, the control circuitry 200 and/or 228 may determine frequency of occurrence of a same type of breach and the location on the field of play where such breach is occurring, and based on an analysis of the breach, provide formation change recommendations. For instance, in a soccer game, if the breach is always happening in the midfield formation and team A has three players for their midfield formation and the opposing team B has five midfielders for their midfield formation, in analyzing the circumstances surrounding the breach, the control circuitry 200 and/or 228 may recommend to team A's coach to change to a four midfielder formation to be in a better position to match up again the opposing team's five midfielders. In another embodiment, one of the parameters, from a plurality of parameters, which may be considered for formation change recommendation may be how much open space is left within the corresponding (defense-mid-forward) formation subset by team A's players. If the opposing team is frequently breaching the formation line in an open space where team A's players are not covering, the control circuitry 200 and/or 228 may analyze whether the players are too close to each other, or the formation needs to be enhanced with another player.

In one embodiment, when a particular player exceeds a threshold number of formation breaches, such as by not following a predetermined formation, the control circuitry 200 and/or 228 may visually augment the breaches and the associated formation on a user interface (such as the breach by 1530 in FIG. 15 where player 1530 lets player 1540 get past them thereby breaching the defense formation). Likewise, in another embodiment, the number of formation breaches successfully achieved (e.g., against the opposing team's formation) by a specific player may also be augmented visually on the user interface that displays the associated streaming video. The visual augmentation for successful breaches may be in a different color than the breaches that are unsuccessful, e.g., not staying in formation of your own team, etc.

At block 107, the control circuitry 200 and/or 228 may determine whether any exceptions for violating the rule are applicable to the players that have breached or violated adhering to the predetermined formation, such as not being in a particular zone, breaching a formation, not guarding the opposing player, etc. There may be a plurality of exceptions that may permit the breach. The exceptions may be inputted by the coach or automatically generated and presented to the coach, owner of the team, or another authorized person, for approval. In some embodiments, one exception to the breach may be if the team is in an attacking situation and the player that has breached may be in possession of the ball, placing him/her in a scoring position. The control circuitry 200 and/or 228 may analyze such game circumstances, such as by analyzing the video, to determine whether an exception applies to the breach. Another exception may be when a player is moving at a high velocity as well as having possession of the ball. Yet another exception may be when a player from the opposing team is guarding too closely and guarding too well and one of the options available to the player to break free from the opposing player was to breach the formation. All such game circumstances may be analyzed in real time (barring any network latencies from the video feed) by the control circuitry 200 and/or 228 to provide recommendations or updates on a user interface. In some embodiments, if the exception applies, the player may be associated with a positive (or neutral) score or rating, and if the exception does not apply the player may be associated with a negative score or rating.

Some examples of updates and recommendations are provided at block 108. The updates, in some embodiments, include updating a user interface of an electronic device associated with a coach, fan, or a broadcaster. In some embodiments, each user may have a different use case of the information and statistics relating to a player, a team, or the game. For example, a fan may want to follow a certain player, vote on a substitution, or use the player in a fantasy sport. A coach may have to make coaching decisions, formation decisions, or substitution decisions based on the information related to the player, the team, or the game overall presented on the user interface. A broadcaster, on the other hand, may want to use the information to provide statistics to the audience. Accordingly, the control circuitry 200 and/or 228, based on the user's profile, may determine whether the user is a coach, a fan, a broadcaster, or some other type of person. Once the type or user is determined, the control circuitry 200 and/or 228 may display different types of information in different formats based on the type of person consuming the information.

In some embodiments, at block 108, the recommendations provided may include whether to keep or substitute a player or signal a player from the sidelines to get back into formation. Such recommendations may be provided to a coach on their electronic device.

In some embodiments, updates may include statistics related to the player or the team, such as player position, player deviation from the predetermined location, player's possession of the ball, or whether the player has scored, lost the ball, lost the defender, or committed a foul.

In another embodiment, the updates provided at block 108 may relate to fantasy scores, ratings, or points associated with a fantasy sport. For example, fans may have some of the players that are currently playing on the field of play as part of their fantasy roster. As such, when a fan selects a particular player, the control circuitry 200 and/or 228 may provide statistics related to that player or provide a score, ratings, or points based on the player's performance in the fantasy sport.

In yet another embodiment, the updates may be provided on the user interface of a fan's electronic device. Such updates on a fan's electronic device may allow the fan to place bets on a player or play, vote on a play or formation, vote on the coach's decision for a substitution, suggest a substitution, and/or make fantasy sports decisions. For example, in one embodiment, fans could bet on which player from the bench could be swapped in based on that player's historical stats being displayed to the user as a better player that will stick to the computed team formation. In another embodiment, fans may vote or bet on what will be the upcoming changed formation of a team during the game. In yet another embodiment, fans may also vote/bet on, based on a future formation, which player will be best choice for a substitution. In yet other embodiments, the fans/audience may also vote on the approval/disapproval of the coach's performance in terms of timing (prompt or waiting on) of the player substitution. In another embodiment, fans may be able to vote on the in-game time frame of when the coach will make a player swap due to formation breakage. In yet another embodiment, fans may vote/bet on whether the coach will be fired after this game due to not having made a player swap or formation change due to formation breakage. In another embodiment, fans may vote/bet on whether the formation change should be for defense, midfield, or forward positions.

In one embodiment, the update provided to the fans may include details or graphics relating to a player that is not adhering to the team formation. For example, extra augmentation (highlight, arrow, color, etc.) may be inserted in real time to draw the attention of the fans/audience to that specific player. The visual augmentation may also display current coordinates versus delta from the desired coordinates where the player is required to be according to game strategy or to be part of a formation.

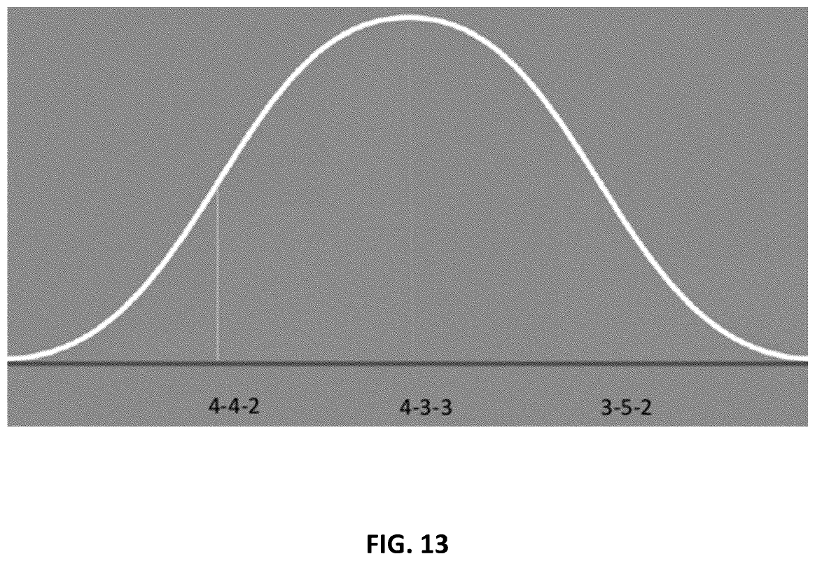

The updates provided on the user interface of an electronic device associated with a coach may differ from updates provided on a fan device. For example, data that is relevant to coaching, making play decisions, using the team's confidential and proprietary plays and overlaying them on the current field of play, are some examples of updates and related recommendations provided only to the coach. In one example, as the game progresses, any changes to the formation as computed by the players' locations and associated with their respective field mates may be updated and reflected on the user interface of an electronic device associated with the coach or the coaching team. Collections of statistics on various formations and designed plays and how they are performed on the field may be displayed as a percentage/bell curve, such as depicted in FIG. 13, on the user interface of an electronic device associated with the coach or the coaching team. The bell curve may highlight the current practiced formation in real time.

FIG. 2 is a block diagram of an example system 200 in accordance with some embodiments of the disclosure. FIGS. 2 and 3 also describe example devices, systems, servers, and related hardware that may be used to implement processes, functions, and functionalities described at least in relation to FIGS. 1, 4-16. Further, FIGS. 2 and 3 may also be used at least for determining team formations during a live game based on video feeds, determining player and team's adherence to identified formations, determining player adherence to an identified location or zone on the field of play, determining whether the current team formation is an offense or defense formation, calculating a distance vector for a player from an identified location, based on an identified formation, to an actual location of the player, providing player substitution suggestions on a user interface, and providing betting options related to player performance on a user interface.

FIGS. 2 and 3 also describe example devices, systems, servers, and related hardware that may also be used at least for obtaining camera view/feeds for a game, where each camera view depicts a different or overlapping view of the field of play, dividing the field of play into a plurality of zones, where zones may cover a specific portion of the field of play or a zone neighboring another player and may be stationary or moving zones, determining a current formation based on performing shape analysis or using other techniques described herein, identifying determined formations on a user interface and outlining the formations, where the outlining, highlighting, or other form of identification provides information relating to the current formation of the team, determining current player location and position and comparing it to identified location or position which may be identified based on a desired formation, such as based on desired game strategy, calculating vectors between current player location and position identified player location and position, generating matrices to perform the comparison and calculation, associating positive ratings, score, points, and rewards for a player that is within an identified zone, location, or position and associating negative ratings, score, points, and rewards for a player that is not within an identified zone, location, or position, determining any exception to the player not being within an identified zone, location, or position and if the exception applies, associating positive ratings, score, points, and rewards for the player whose actions qualify for the exception, providing display updates on different devices, such as fan device, coaching device, broadcasting device, where information for each separate type of device is customized to its user, providing a platform for fantasy sports or providing fantasy score, points, ratings for a player based on their adherence to identified formations, associating coach with positive of negating ratings, points, and scores based on the coach's performance, including substitution of a player and utilizing NLP, AI, and ML engines to execute associated algorithms for determining various solutions described herein, and performing functions related to all other processes and features described herein.

In some embodiments, one or more parts of, or the entirety of system 200, may be configured as a system implementing various features, processes, functionalities and components of FIGS. 1, and 4-16. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., obtained camera view of the field of play, zones of the field of play, identified player or team formations, player's current position, calculated vectors, generated matrices to compare player's current location and position with an identified location or position, list of exceptions to player violating or breaching an identified location or formation, substitution recommendations, player statistics, coach statistics, player substitution statistics and results of the substitution, points, scores, ratings, and rewards associated with or awarded to each player, and AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to camera view of the field of play, zones of the field of play, identified player or team formations, player's current position, calculated vectors, generated matrices to compare player's current location and position with an identified location or position, list of exceptions to player violating or breaching an identified location or formation, substitution recommendations, player statistics, coach statistics, player substitution statistics and results of the substitution, points, scores, ratings, and rewards associated with or awarded to each player, AI and ML algorithms and data relating to all other processes and features described herein, may be recorded and stored in one or more of storages 212, 238.

In some embodiments, control circuitries 220 and/or 228 executes instructions for an application stored in memory (e.g., storage 224 and/or storage 238). Specifically, control circuitries 220 and/or 228 may be instructed by the application to perform the functions discussed herein. In some implementations, any action performed by control circuitries 220 and/or 228 may be based on instructions received from the application. For example, the application may be implemented as software or a set of executable instructions that may be stored in storage 224 and/or 238 and executed by control circuitries 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, the control circuitry 228, in response to determining that a player has violated or breached an identified location or formation, may associate negative points, scores, or ratings, for the player. The control circuitry 228 may also perform steps of processes described in FIGS. 1, 4-16.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as identified player location or team formation. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, a mixed reality device, or any other device, computing equipment, or wireless device, and/or combination of the same that is capable of performing the embodiments disclosed herein.

Control circuitries 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core 19 processor). In some embodiments, control circuitries 220 and/or control circuitry 218 are configured for determining team formations during a live game based on video feeds, determining player and team's adherence to identified formations, determining player adherence to an identified location or zone on the field of play, determining whether the current team formation is an offense or defense formation, calculating a distance vector for a player from an identified location, based on an identified formation, to an actual location of the player, providing player substitution suggestions on a user interface, and providing betting options related to player performance on a user interface. The control circuitries 220 and/or control circuitry 218 are also configured for obtaining camera view/feeds for a game, where each camera view depicts a different or overlapping view of the field of play, dividing the field of play into a plurality of zones, where zones may cover a specific portion of the field of play or a zone neighboring another player and may be stationary or moving zones, determining a current formation based om performing shape analysis or using other techniques described herein, identifying determined formations on a user interface and outlining the formations, where the outlining, highlighting, or other form of identification provides information relating to the current formation of the team, determining current player location and position and comparing it to identified location or position which may be identified based on a desired formation, such as based on desired game strategy, calculating vectors between current player location and position identified player location and position, generating matrices to perform the comparison and calculation, associating positive ratings, score, points, and rewards for a player that is within an identified zone, location, or position and associating negative ratings, score, points, and rewards for a player that is not within an identified zone, location, or position, determining any exception to the player not being within an identified zone, location, or position and if the exception applies, associating positive ratings, score, points, and rewards for the player whose actions qualify for the exception, providing display updates on different devices, such as fan device, coaching device, broadcasting device, where information for each separate type of device is customized to its user, providing a platform for fantasy sports or providing fantasy score, points, ratings for a player based on their adherence to identified formations, associating coach with positive of negating ratings, points, and scores based on the coach's performance, including substitution of a player and utilizing NLP, AI, and ML engines to execute associated algorithms for determining various solutions described herein, and performing functions related to all other processes and features described herein.

Computing device 218 receives a user input 204 at input circuitry 216. For example, computing device 218 may receive data relating to current player location or position and identified location and position. Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4-16, respectively.

FIG. 3 is a block diagram of a user device 300 in accordance with some embodiments of the disclosure. In an embodiment, the equipment device 300, is the same equipment device 202 of FIG. 2. The equipment device 300 may receive content and data via input/output (I/O) path 302. The I/O path 302 may provide audio content. The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor).

In client-server-based embodiments, the control circuitry 304 may include communications circuitry suitable for determining team formations during a live game based on video feeds, determining player and team's adherence to identified formations, determining player adherence to an identified location or zone on the field of play, determining whether the current team formation is an offense or defense formation, calculating a distance vector for a player from an identified location, based on an identified formation, to an actual location of the player, providing player substitution suggestions on a user interface, and providing betting options related to player performance on a user interface. The control circuitry 304 may also include communications circuitry suitable for obtaining camera view/feeds for a game, where each camera view depicts a different or overlapping view of the field of play, dividing the field of play into a plurality of zones, where zones may cover a specific portion of the field of play or a zone neighboring another player and may be stationary or moving zones, determining a current formation based om performing shape analysis or using other techniques described herein, identifying determined formations on a user interface and outlining the formations, where the outlining, highlighting, or other form of identification provides information relating to the current formation of the team, determining current player location and position and comparing it to identified location or position which may be identified based on a desired formation, such as based on desired game strategy, calculating vectors between current player location and position identified player location and position, generating matrices to perform the comparison and calculation, associating positive ratings, score, points, and rewards for a player that is within an identified zone, location, or position and associating negative ratings, score, points, and rewards for a player that is not within an identified zone, location, or position, determining any exception to the player not being within an identified zone, location, or position and if the exception applies, associating positive ratings, score, points, and rewards for the player whose actions qualify for the exception, providing display updates on different devices, such as fan device, coaching device, broadcasting device, where information for each separate type of device is customized to its user, providing a platform for fantasy sports or providing fantasy score, points, ratings for a player based on their adherence to identified formations, associating coach with positive of negating ratings, points, and scores based on the coach's performance, including substitution of a player and utilizing NLP, AI, and ML engines to execute associated algorithms for determining various solutions described herein, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to store various types of content, (e.g., obtained camera view of the field of play, zones of the field of play, identified player or team formations, player's current position, calculated vectors, generated matrices to compare player's current location and position with an identified location or position, list of exceptions to player violating or breaching an identified location or formation, substitution recommendations, player statistics, coach statistics, player substitution statistics and results of the substitution, points, scores, ratings, and rewards associated with or awarded to each player, and AI and ML algorithms, and data relating to all other processes and features described herein). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application.

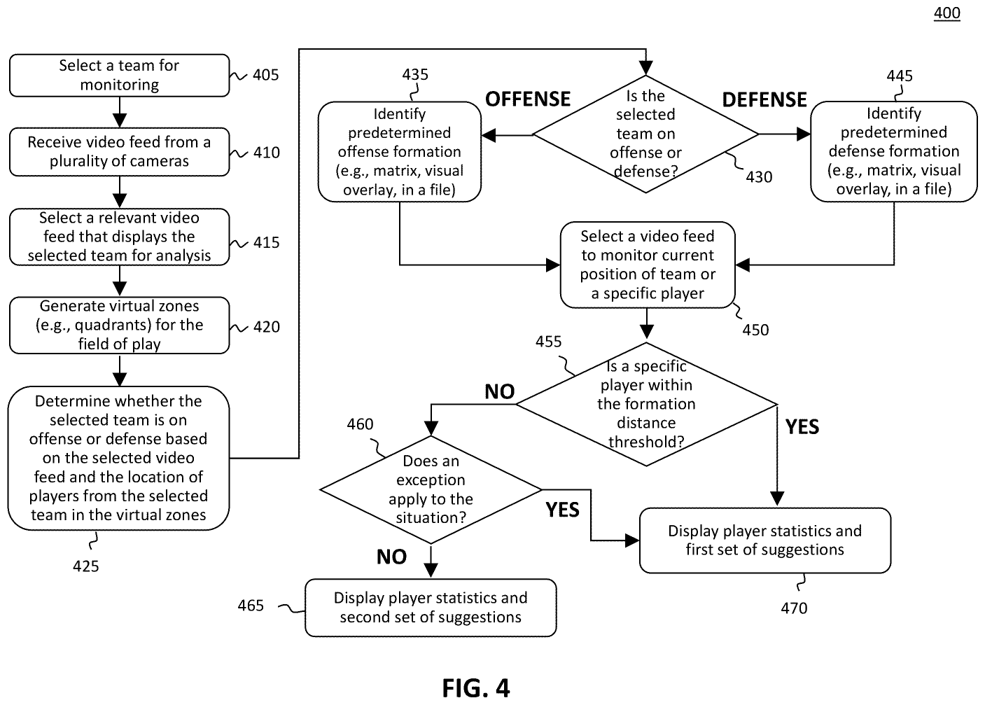

FIG. 4 is a flowchart of a process 400 for displaying game statistics and providing player-related suggestions, in accordance with some embodiments of the disclosure. The process 400 may be implemented, in whole or in part, by systems or devices such as those shown in FIGS. 2-3. One or more actions of the process 400 may be incorporated into or combined with one or more actions of any other process or embodiments described herein. The process 400 may be saved to a memory or storage (e.g., any one of those depicted in FIGS. 2-3) as one or more instructions or routines that may be executed by a corresponding device or system to implement the method 400.

In some embodiments, at block 405, a team for monitoring may be selected. For example, a coach using a coaching device may select their own team for monitoring. In another embodiment, a fan using an electronic device may select one of the two teams that is their favorite. In another embodiment, a broadcaster may select both teams for monitoring such that it can provide commentary on both teams performances. Selection may be made by using a user interface and selecting one of the teams, such as by using a cursor, touchscreen, or voice input. In another embodiment, the control circuitry 200 and/or 228 may access the profile of the user device and based on historical selections automatically select a team for monitoring. For example, if the control circuitry 200 and/or 228 based on the analysis of a user profile determines that the Golden State Warriors or Real Madrid is a favorite of the user or is the user's home team, then the control circuitry 200 and/or 228 may automatically select that team for monitoring.

In some embodiments, at block 410, the control circuitry 200 and/or 228 may receive a plurality of camera feeds. As described earlier, these may be live videos captured by the cameras on the field of play. Since there are multiple cameras on a field of play, each camera may be capturing and transmitting a different feed that shows a different portion of the field of play, the stadium, or the surroundings of the stadium.

At block 415, the control circuitry 200 and/or 228 may select a relevant video feed that displays the selected team for analysis. For example, if a team to be monitored is the NBA team the Golden State Warriors or the soccer team Real Madrid, selected at block 405, then of the plurality of video feeds that display different footage of the game, a relevant video feed that is focused on the Golden State Warriors or the Real Madrid players may be selected for further analysis. More specifically, a user may desire to track a particular player on a team, such as Tony Kroos on the Real Madrid team, and accordingly, the control circuitry 200 and/or 228 may select a video feed that focuses on or shows Tony Kroos while he is on the field.

At block 420, the control circuitry 200 and/or 228 may generate virtual zones such as quadrants, for the field of play. Some examples of such zones are depicted in block 102 of FIG. 1 and in FIGS. 6 and 7. The zones, as described earlier, are virtual boundaries that define a portion of the field of play. For example, in a basketball game, the control circuitry 200 and/or 228 may generate zones 1-3 as depicted in FIG. 6. In another example, as depicted in FIG. 6, the control circuitry 200 and/or 228 may generate four zones for an ice hockey game. In yet another example, as depicted in FIG. 6, the control circuitry 200 and/or 228 may generate 10 zones for a soccer game.

In some embodiments, the placement of the zones may be relative to the type of game and the field of play, and to having proper zone coverage in key areas of the field of play. For example, a key area in a soccer game may be the area around the goal, and key areas in a basketball court may be areas near the basket or the three-point line where game scoring action takes place.

In some embodiments, the number of zones to be generated may also be dependent on the type of game and field of play. For example, a large field may have a larger number of zones to ensure proper coverage, while a smaller field of play may have fewer zones.

At block 425, the control circuitry 200 and/or 228 may determine whether the selected team or a selected player is on the offense or defense. The control circuitry 200 and/or 228 may do so based on the selected video feed and the location of the player in one of the selected zones. The control circuitry 200 and/or 228 may also determine whether a player or a team is on the offense or defense based on other factors such as possession of the ball, the team's formation, a shape analysis of the team's formation reflecting whether it is an offense or defense formation, or metadata obtained from the provider. Other methods of determining whether the player or the team is on offense or defense, as discussed in the embodiments above, may also be used.

Once a determination is made, at block 430, whether the team is on offense or defense, next steps as depicted at blocks 435 or 445 may be taken. For example, if the control circuitry 200 and/or 228 determines that the selected team or the player is on the offense, then, at block 435, the control circuitry 200 and/or 228 may identify a predetermined offense formation for the player or the team. The predetermined offense formation or the predetermined offense location of a player may be in accordance with a designed play by a coach. For example, based on the stage of the game, the coach may have implemented a strategy for the team to come together in a particular formation to increase their chances of scoring a goal in a soccer match. One such example may be a 4-3-3 formation to implement an offensive attack for scoring a goal in the opposite team's goal. If a predetermined location is identified for a player, such as requiring the player to be in a particular zone or to be within a particular threshold distance of another player, then such predetermined location may also be identified.

Likewise, if a determination is made at block 430 that that player or the current team is in a defense formation, then the control circuitry 200 and/or 228 may identify a predetermined defense formation or a predetermined defensive location for a particular player.

At block 450, the control circuitry 200 and/or 228 may select a video feed to monitor the current position of the team or a specific player. The control circuitry 200 and/or 228 may access a plurality of cameras and select a video feed that provides the footage of the selected team or the player.

At block 455, the control circuitry 200 and/or 228 may determine whether a specific player or the team is within the formation distance threshold. For example, if the identified predetermined formation at block 435 or 445 calls for the player to be in a specific zone or for different players on the team to be in certain designated zones or within a predetermined distance of each other, then the determination at block 455 may be to determine whether the player and the team are sticking to the predetermined locations and formations.

If a determination is made, at block 455, that a specific player or the team is within the distance threshold of the predetermined location, then, at block 470, statistics, updates, and recommendations related to the specific player and the team may be provided on the electronic devices associated with the coaching team, fans, broadcasters and others. The statistics, updates, and recommendations provided may be customized based on the user's or the user device's profile and the use case for the information. For example, if the statistics, updates, and recommendations are being provided on a user interface of an electronic device associated with a coaching team, then information that may be helpful in making coaching decisions based on the player's sticking to the formation may be provided. In some embodiments, analysis of team formation, player performance, player ratings based on player performance and adherence to identified formations may be provided to broadcasts to enhance viewer engagement. Such insights may be provided on the user interfaces of a viewer/fan, broadcaster, in real-time, which includes player performance, team strategies, interactive content (gamifying the viewing experience, including polls, gambling/fantasy sports, etc.). In some embodiments, the insights may be customized whether the user is a fan or a broadcaster who is looking for more analytical data. In some embodiments, the insights, enhanced viewer engagement information, player performance, team strategies, interactive content and other player, team, coach related statistics and analysis may be provided as a separate broadcast, or it may be added to the same broadcast and presented as supplemental content that the user may view if they desire. For example, in some embodiments, supplemental content may be presented as a pop up on the user interface used by the user to watch the game. In another embodiment, the user may be sent a notification with a selection option and if the user selects the option, then supplemental content may be displayed as a pop-up, at the bottom of the user interface, in a separate window, or be sent to a separate device.

Supplemental content may engage the viewer such that the viewer stays interested in the game. For example, in one embodiment, the player may highlight a player of interest and as the game progresses and the player moves about the field of play, the player will continue to be highlighted on the user's user interface such that the user may track the movement of the player. In another embodiment, the user may change the color of the ball, the t-shirt color of the player, on their user interface and the control circuitry 200 and/or 228 may overlay the ball or the player's T-shirt with the user desired color. In another embodiment, the game may be made interactive where a user may gamify any scene or play in the actual game to a video game. In this embodiment, the control circuitry, if a gamify option is selected by the user, may convert a scene into a digital representation and the user may then proceed to playing it as a video game. For example, if in a real game, the video feed shows the football player Cristiano Ronaldo getting ready for a penalty kick, the user may select a gamify option based on which the control circuitry 200 and/or 228 may then convert the game into a digital video game where all players and field of play is converted into a digital representation. The user may, using the gamified option, which would turn the game into a virtual game, then take the penalty shot by aiming the soccer ball in any desired corner of the goal. The user may also be presented with interactive options in the virtual game to have Cristiano Ronaldo take the shot or substitute him with the user himself/herself or another player, such as Lionel Messi, to further keep the user engaged and interactive in the game. The user may also adjust speed of the shot and select other interactive features that allow the user to curve the shot into the goal, etc. The user may then switch back to the actual game at any time by selecting an option to return to the game. Other interactive options may also be presented to the user by the control circuitry and the user may also use API's to import their own interactive features from other external applications. The user may, in some embodiments, be able to play the virtual game simultaneously while consuming the actual game, such as by the control circuitry splitting the screen to display both the actual and virtual game.

Such supplemental content may also be provided when a determination is made that the user is losing interest in the game. For example, the control circuity may track the user's gaze as it is directed to the user interface on which the user is consuming the game and if based on a gaze a determination is made that the user's line of sight is some place other than the game, then supplemental content, including interactive features described above, that is of interest to the user (determined by user profile or user history) may be provided.

If a determination is made, at block 455, that a specific player or the team is not within the formation distance threshold, e.g., not sticking to a predetermined formation, then at block 460, the control circuitry 200 and/or 228 may determine whether an exception to the rule is applied based on the circumstances of the game.

Some examples of exceptions are provided in the description related to block 107 of FIG. 1. In addition to the exceptions described earlier, other exceptions may be inputted by the coach or automatically generated and presented to the coach, owner of the team, or another authorized person for approval. All such game circumstances may be analyzed in real time (barring any network latencies from the video feed) by the control circuitry 200 and/or 228 to determine whether an exemption for violating or breaching the predetermined formation or exceeding the threshold distance from a zone or another player is permissible. To perform the analysis, the control circuitry 200 and/or 228 may analyze video of the game.

If a determination is made, at block 460, that the exception applies, then the process may move to block 470, where statistics related to the player, updates, and recommendations that correlate with the player's moves or the team's moves surrounding the breach and the exception may be provided on a display.

If a determination is made, at block 460, that the exception does not apply, i.e., that the player or the team has breached the rules (e.g., to be in formation, to stay within a threshold distance of a zone or another player, to let a player on the opposing team pass by due to improper defense, etc.), then updates, statistics, and recommendations that reflect the breach may be displayed on an electronic device, such as a coaching team, fan, or broadcaster's electronic device. The control circuitry 200 and/or 228 may also detect patterns of positive play and negative play (e.g., breach) for each player and the team, the team when they are in a specific location of the field (e.g., midfield in a soccer game), or under a particular circumstance (e.g., when under pressure, when guarded by a specific player, when the opposing team has a certain formation), and statistics, updates, and recommendations that correlate with such patterns may be provided for display.

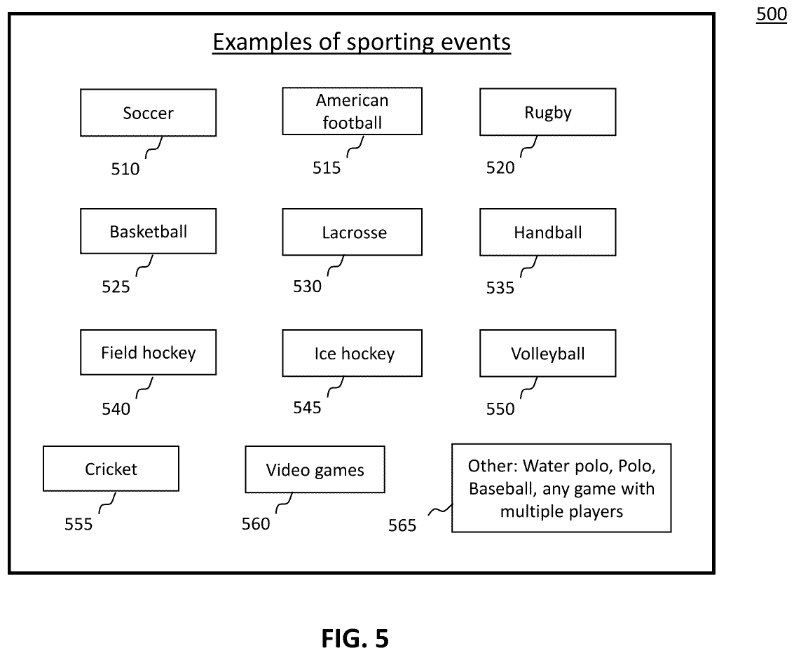

FIG. 5 depicts examples of types of sports or events to which embodiments described herein may be applied, in accordance with some embodiments of the disclosure. In some embodiments, the methods and systems described herein may be used in at least the following sports: soccer 510, American football 515, rugby 520, basketball 525, lacrosse 530, handball 535, field hockey 540, ice hockey 545, volleyball 550, cricket 555, video games 560, or other sports 565, such as water polo, polo, baseball or any other sports event with multiple teams and multiple players.

Although live games have been the focus of discussion in the embodiments, the embodiments are not so limited, and video games that involve multiple teams or multiple players are also contemplated within the embodiments. In such video gaming environments, when one player has a virtual team that is playing against another player's virtual team, the performance of the team, performance of the player, and their adherence to a predetermined game plan, such as sticking within a zone or within a distance of another player, are evaluated in the same manner as described for live sports games.

FIG. 6 depicts examples of different fields of play that are divided into a plurality of zones, in accordance with some embodiments of the disclosure. As described earlier, each field of play may be divided into a plurality of zones. The number of zones, the dimensions of the zone, and the placement of the zone may be determined by the control circuitry 200 and/or 228 based on the type of sport and the field of play. For example, a field of play that covers a large area, such as a soccer field or an American football field, may be divided into a larger number of zones than a smaller field of play, such as a basketball court. This is because having more zones in a larger field of play may allow a higher level of accuracy in tracking play within that zone. The zones that are displayed on the user interface of an electronic device are arbitrary and virtual. In some embodiments, the zones are on the back end and never displayed to the user. In other embodiments, the user may select to have the zones displayed as an overlay on the live video. In some embodiments, the zones may be used to calculate a vector from a zone in which a player is predetermined to be in accordance with a designed play or formation to a current location where the player is during the game.

In some embodiments, the zones may be stationary and tied to the field of play, such as to particular positions on the field of play (e.g., area inside the paint in basketball, in the last 10-yards of an American or Canadian football in the midfield for a soccer game, etc.).

In another embodiment, the zone may be moving with respect to the field of play. Some examples of a “moving” zone may include a first player playing one-on-one defense when guarding another player in a particular a defense formation. In this scenario, the first player from team A may be defending a first player from team B. As the first player from team B moves on the field of play, the zone may also move with respect to the movement of the first player on team B. In this scenario, since the first player on team A is to stay within an identified distance of the first player on team B, such that the first player on team B is well guarded and not left open, the performance of the first player on team A may be determined with respect to the moving zone to determine whether the first player on team A is properly guarding the first player on team B.

In yet another embodiment, a player from the opposing team, when in possession of the ball, may need to be double or tripled teamed. For example, based on historical data and player's ability, a determination may be made that when Stephan Curry (a player on the Golden State Warriors basketball team) is outside the paint and has the ball, based on historical data, is likely to shoot a 3-pointer. As such, to defensively guard Curry better in such scenarios, a double or triple team defense may be needed. In such circumstances, the moving zone may require at least two identified players to be within a threshold distance of Stephan Curry. If the two identified players are not within the predetermined distance to double team Curry, then the control circuitry 200 and/or 228 may determine that the two defensive players that were to guard Stephan Curry have breached their formation (i.e., were not within threshold distance of the moving zone, which may be anchored to Stephan Curry such that the moving zone moves as Stephen Curry moves on the basketball court).

In some embodiments, the control circuitry 200 and/or 228 may automatically identify moving zones and what a player or the team needs to do in order to stay within the zone. For example, the control circuitry, using AI, may analyze all historical game data for all or some games between the Los Angeles Lakers and the Golden State Warriors. Based on the analysis, the control circuitry 200 and/or 228 may determine that at a particular location on the basketball court, when Lebron James (a Los Angeles Lakers' player) has possession of the ball and is guarded by a specific defensive player from the Golden State Warriors, 73% of the time Lebron James had performed a spin move to lose the defender and dunk the ball into the basket. As such, the control circuitry 200 and/or 228 may automatically create moving zones and indicate that two (or three) players from the Golden State Warriors need to double team Lebron James or have a second defender near the basket to guard Lebron James when he does the spin move. The control circuitry 200 and/or 228 may indicate the moving zones, provide related notifications, on the user interface of a coaching device such that the coaches of the Golden State Warriors may make appropriate defensive adjustments in the game. The control circuitry 200 and/or 228 may also provide related statistics to the coaching team of the Golden State Warriors in their user interface, e.g., such as the statistics described above relating to Lebron James performing the spin move 73% of the times specifically when a particular player is guarding him. In some embodiments, the control circuitry 200 and/or 228 may provide substitution notifications to the coach to substitute out particular player since the particular player, based on historical data, allowed Lebron James to perform the spin move on him 73% of the time. The control circuitry 200 and/or 228 may suggest another player on the bench of the Golden State Warriors that has guarded Lebron James better in such situations and present the data to the coaching staff on their user interface.

FIG. 7 is an example of an offensive formation in a soccer game that depicts locations of players in different zones, in accordance with some embodiments of the disclosure. In this example, a soccer team formation of 4-3-3 is displayed. According to the formation, the predetermined location places four players in zone 4, one player in zone 3, one player in zone 5, two players in the goal zone, one player in zone 1, and one player in zone 2. In some embodiments, the control circuitry 200 and/or 228 may access live video feeds that are focused on zones 1-5 and the goal zone to determine whether the players are currently in their predetermined zones. In some embodiments, the process may include determining a current location of each player and then comparing it with their predetermined location. The control circuitry 200 and/or 228 may then calculate a vector from the predetermined location to the current location to determine a distance differential. If the distance differential exceeds a threshold, then the control circuitry 200 and/or 228 may determine that the player is outside the zone or exceeds the predetermined distance threshold. Accordingly, the control circuitry 200 and/or 228 may take any of the actions as described earlier in block 108 of FIG. 1. The control circuitry 200 and/or 228 may also use matrices to compute the distance differential. In another embodiment, the control circuitry 200 and/or 228 may overlay the predetermined locations on a user interface on actual live video to visually display the distance differential. The control circuitry 200 and/or 228 may visually display by pointing an area arrow (not shown) from the predetermined location to the player's current location. If the breach by the player, the players, or the team is not following the predetermined formation, then the control circuitry 200 and/or 228 may display the predetermined formation and draw lines to indicate the difference between the predetermined and the current formation.

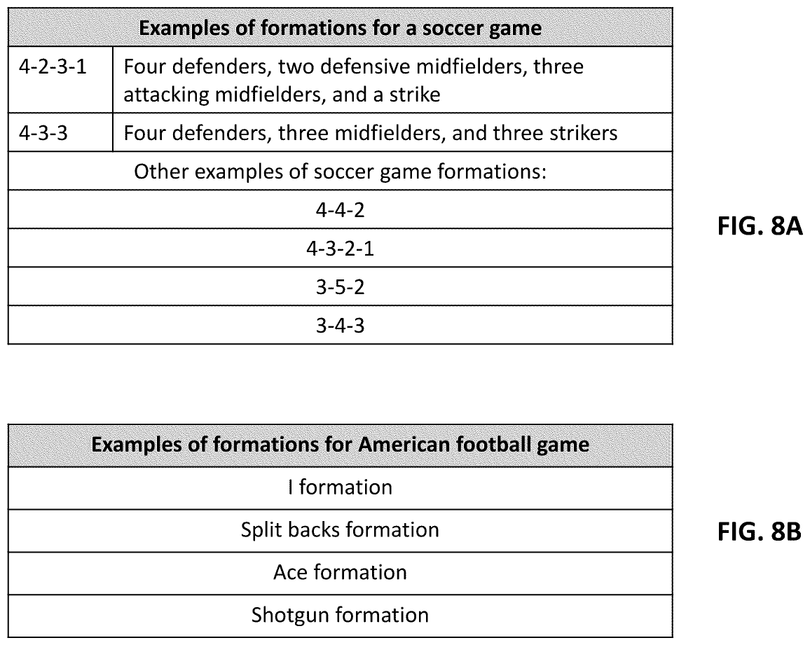

FIGS. 8A and 8B are some examples of tables of a plurality of formations in a soccer game and an American football game, respectively, in accordance with some embodiments of the disclosure. In some embodiments, these may be predetermined formations, and the control circuitry 200 and/or 228 may monitor the players on the field to determine whether they are adhering to these predetermined formations at the particular stage of the game for which they are designed.

In another embodiment, the control circuitry 200 and/or 228 may monitor the movement of the players as the game progresses and predict which formation the players are likely going to be forming into based on their current pattern of movement. If the players deviate from the predictable formation, the control circuitry 200 and/or 228 may calculate the deviation, i.e., the distance differential, and alert the coach accordingly. Although the embodiments herein focus on comparing the predetermined formation or location with the current formation or location, the embodiments are not so limited, and any predictive formation that the control circuitry 200 and/or 228 anticipates based on the team's forward movement may also be used as a predetermined location or formation to compare to the current location or formation of the players.

In some embodiments, a current formation or a prediction for a formation that is likely to occur may be determined based on performing a shape analysis or a zone analysis. In these embodiments, the control circuitry 200 and/or 228 may analyze a live video feed from one or more cameras and, based on the location of players depicted in the live video feed, may compute a shape. The shape computation may involve drawing lines between the players to determine the possible shapes based on the current location of the players. The control circuitry 200 and/or 228 may then compare the shapes to a list of traditional shapes for the sport to the identify the closest shape. In other words, if the closest shape based on the computation of the locations of players is a 4-3-3 shape in a soccer match, then the control circuitry 200 and/or 228 may determine, based on the calculated shape, that the current formation is a 4-3-3 formation. When a zone analysis is performed, the control circuitry 200 and/or 228 may analyze a live video feed from one or more cameras and, based on the location of players depicted in the live video feed, determine whether the players are in a zone to which they are assigned.

In some embodiments, shape analysis may also be performed to predict a formation that is likely to occur. For example, the team players may be moving at a particular pace and towards the opposing side's basket in a basketball game or a goal in a soccer game when they are on offense or towards their own basket or goal in a basketball or soccer game when the team is in a defending formation. The control circuitry 200 and/or 228 may track the pace of their movement and the direction of the player movement to predict a future location of the players and a likely formation that will occur. For example, if a player is moving at a certain velocity towards the opposite team's goal, the control circuitry 200 and/or 228 may calculate the distance the player will cover if the player maintains the same velocity and accordingly determine the next location of the player, such as in X seconds. Likewise, the control circuitry 200 and/or 228 may monitor the pace and direction of the remaining players on the team to determine their future locations and use all such future locations to predict a formation that is likely to occur.

FIG. 9 is a block diagram of players' names, their jersey numbers, and play positions for a first and a second team, in accordance with some embodiments of the disclosure. In this example, rosters of the United States and Iranian team during the World Cup 2022 match are displayed. The control circuitry 200 and/or 228 may access such rosters from the service providers and input them into the system, such as system displayed in FIG. 2. Once the names of the players, their jersey numbers, and positions from the rosters are inputted, the control circuitry 200 and/or 228 may track each player by their jersey number as the player moves about the field of play. Such tracking may be performed by the control circuitry 200 and/or 228 accessing a video feed that is focused on the particular player. Accordingly, the control circuitry 200 and/or 228 may update statistics related to each player based on tracking the player's performance.

FIG. 10 is an example of a matrix of distance differentials for each player being monitored, in accordance with some embodiments of the disclosure. In some embodiments, in a soccer match, a predetermined formation may be a 4-3-3 formation. In another embodiment, the control circuitry 200 and/or 228 may be monitoring the movement of the players and may anticipate and predict, based on the movement, that the players are about to get into a 4-3-3 formation. Regardless of whether the 4-3-3 formation was a predetermined formation or predicted by the control circuitry 200 and/or 228, based on the movement of the players, in order to adhere to the 4-3-3 formation, each player may need to be within a relative distance of another player. For example, if players Robinson, Vickers, Ream, and Dest are to form the “4” of the 4-3-3 formation, they may be tracked to determine whether they are adhering to the formation. To determine whether they are adhering to the formation, the control circuitry 200 and/or 228 may generate a first matrix that includes predetermined threshold distances between each pair of players to which the players would need to adhere to in order to form the “4” of the 4-3-3 formation. The control circuitry 200 and/or 228 may generate a second matrix, as depicted in FIG. 10, based on the current locations of the players Robinson, Vickers, Ream, and Dest. The control circuitry 200 and/or 228 may populate this second matrix with actual distances between each pair of the players that form the “4” of the 4-3 -3formation. Control circuitry 200 and/or 228 may then compare the first matrix with the second matrix to determine whether the players are within the threshold distances of where they are supposed to be in order to adhere to the 4-3-3 formation.

In some embodiments, the control circuitry 200 and/or 228 may analyze the distance values or distance vectors of the computed matrices to filter which player is sticking with the formation best versus which player is not adhering to the formation. For players sticking with the formation, the control circuitry 200 and/or 228 may look up the lowest values, and for players not sticking with the formation or the predetermined location, the control circuitry 200 and/or 228 may look up the highest values in terms of standard deviations. For the players not sticking with the formation, if the standard deviation value computed is higher than the one third of the length or width of the field, the control circuitry 200 and/or 228 may indicate such data as an outlier in the time series data. In another embodiment, if the distance of this player is more than an order of magnitude higher than the highest distance between their formation mates' inter-distance, then this player may be deemed by the control circuitry 200 and/or 228 to not be sticking with the assigned formation. Such a player, i.e., the player breaching or not sticking with the formation, may be added to a probation list to evaluate the running distance value or distance vector average over time.

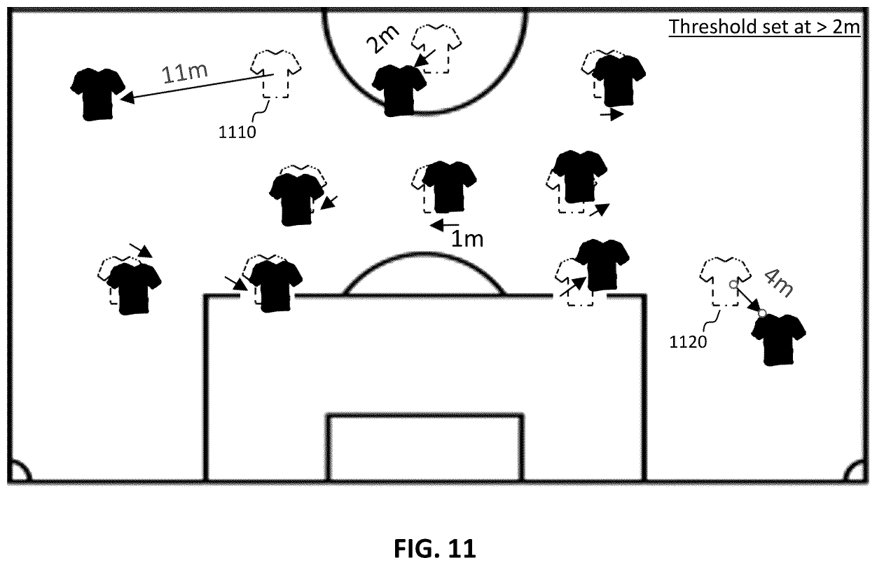

FIG. 11 is an example of visually displaying the distance differentials for each player being monitored, in accordance with some embodiments of the disclosure. In some embodiments, there may be at least three types of distance differentials that may be calculated for each player. These distance differentials may be 1) the distance differential from where the player is currently located and where the player is predetermined to be located with respect to a zone, 2) the distance differential from where the player is currently located and where the player is predetermined to be located with respect to another player from the same team, e.g., in a particular formation, the player may be predetermined to be within a certain distance from another player to conform to a formation, and 3) the distance differential from where the player is currently located and where the player is to be located with respect to a player from the opposing team, e.g., when playing defense, the player is to be located in close proximity to a player from another team such that the player from the opposing team is well guarded. In some embodiments, the control circuitry 200 and/or 228 may visually display on a user interface any of the three distance differentials described above. For example, the control circuitry 200 and/or 228 may visually display on a user interface the distance differential between a predetermined location or a predetermined formation and a current location or a current formation of a player or the team as depicted in FIG. 11. The control circuitry 200 and/or 228 may also draw a vector from the predetermined location to the current location of a player and indicate the distance differential. In one example, if the threshold distance is set at two meters, e.g., each player is required to be within two meters of their predetermined location, which may be anchored to a zone, then, if the player exceeds the two-meter distance threshold, e.g., the player is more than two meters from the zone, then the control circuitry 200 and/or 228 may determine that the player is in violation or breach of the predetermined distance threshold. As depicted in FIG. 11, the two players that violate the distance threshold are players 1110 and 1120 that are at 11 meters and four meters, respectively, from their predetermined location. Accordingly, for each player that does not violate their predetermined location, statistics may be updated to reflect their adherence to the predetermined locations while statistics for the two players who breached may also be updated accordingly.

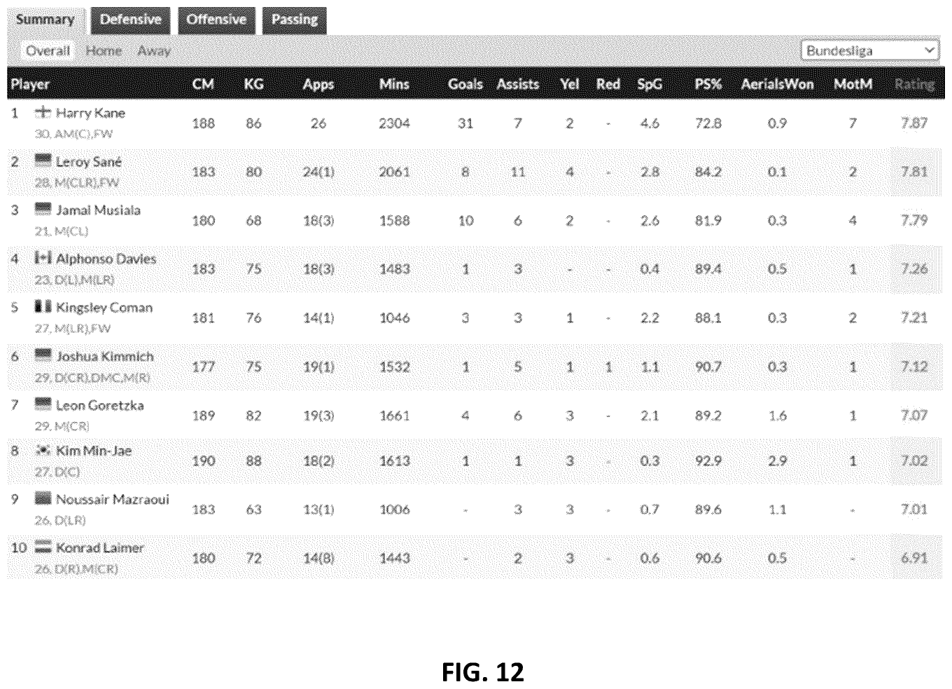

FIG. 12 is a table of player statistics, in accordance with some embodiments of the disclosure. In some embodiments, the control circuitry 200 and/or 228 may update the statistics in real time based on player performance. For example, the control circuitry 200 and/or 228 may update these statistics by increasing the ratings of a player that adheres to their determined location or formation and decrease the ratings of a player that does not adhere to their determined location or formation.

In addition to the statistics displayed in FIG. 12, statistics may be obtained for each player for the entire season or over a course of games. This metadata about specific players will be recorded, for example, over each game they have played. The data recorded may be both in terms of minutes as well as percentage of their play time during the game that they were sticking with the team formation. Moreover, the control circuitry 200 and/or 228 may also record data about how far this player is away from their formation mates. For instance, the control circuitry 200 and/or 228 may save the percentage value of this inter-formation distance delta of this player with respect to the highest distance between other players in the same formation. The worst offending value for a player may be the farthest distance away from their cluster with the longest amount of time. These two values may be multiplied by the control circuitry 200 and/or 228 with varying coefficient values to arrive at a final value. This final value may be a representation of the player and how well they stick to the formation.

In some embodiments, after identifying the first player that is not sticking to a formation, looking at historic data, another bench player with a better track record (for instance, time and/or percentage wise) for the identified formation may be suggested as the player to be substituted with the first player. This may be a specific recommendation that the control circuitry 200 and/or 228 may display only on the devices associated with the coaching team since the recommendation may also be based on the team's strengths, strategies, game plans, etc., which may be confidential to the team.

In some embodiments, the recommendation of substitution may be presented to the coach, or the coaching team, accompanied with other stats about the offending player, such as having in-game positive (having scored a goal, having high ball possession stats) or negative (having received a penalty card or sustained an injury) connotation metrics. The reason for the substitution, in some embodiments, whether suggested by the system or coach-initiated, may be due to a player not adhering to team formation, being visibly tired based on image analysis of the player (which may be monitored automatically by the control circuitry), exceeding their playing minutes, being injured, etc. By providing the additional information and statistics, the control circuitry 200 and/or 228 may allow the coach to consider the substitution recommendation in light of all the parameters associated with the player to be substituted. As such, the coach may only not only pay attention to the discipline of sticking with the team formation but also may ensure the substitution is not at the expense of other performance factors by the offending player (e.g., often scores a goal after X minutes in the game, etc.).

In addition to the factors described above, the control circuitry 200 and/or 228 may present other player-related factors to the coach along with the recommendation. For example, the control circuitry 200 and/or 228 may indicate, concerning the player violating the formation, how the breach occurred and how close the opposing team's player was when the breach occurred. Since the control circuitry 200 and/or 228 may also compute the opposing team's formation, and if the team formation-violating player is consistently very close (one average human body size or say 30-50 centimeters) to the opposing team's player, thus executing the responding formation on behalf of their team, this formation-violating player may get an exemption for these situations. In other words, if the other team's player is defending the player that breached very closely or very well, an exception for violating the formation may be made, and such data may be provided to the coach to evaluate the player in the totality of the circumstances.

Although ratings, scores, points, and performances of a player have been used to describe the embodiments, the embodiments are not so limited, and performance of the coach and the coaching team, including the offensive coach, defensive coach, etc., and team management personnel, may also be rated and their performance scored. For example, if a coach calls a time-out too late, does not execute a strategy efficiently, does not substitute a player, or substitutes with a player at the wrong time in the game or with an incompatible player who is not able to defend the opposing side player, then the coach's performance may also be affected. For example, in one embodiment, the control circuitry 200 and/or 228 may send a notification to a coach to substitute a player. The control circuitry 200 and/or 228 may also provide details as to which player to substitute out of the game and which player to use for substituting into the game. The control circuitry 200 and/or 228 may also display multiple options for substituting into the game, where the multiple options may include a choice of selecting between one or more players on the bench to use for substitution and provide player statistics associated with the multiple one or more players on the bench that can be substituted into the game, e.g., such as in a pop up or in a window of the user interface. The coach may then choose to agree or ignore the substitution notification. If the lack of substitution results in loss of points, then the coaching team may be associated with a negative score, points, ratings, etc. On the other hand, if the coach or the coaching team performs well, either for the substitution or otherwise, their score may be increased.

FIG. 13 is a bell curve that displays team effectiveness of formations used by a team during a game, in accordance with some embodiments of the disclosure. In some embodiments, the control circuitry 200 and/or 228 may monitor the different formations of the game as the game progresses. For example, the three formations shown in FIG. 13 include a) 4-4-2, b) 4-4-3 and c) 3-5-2 formations. For each formation, the control circuitry 200 and/or 228 may determine whether the players adhere to the predetermined formation and how the team performs overall. As reflected in the bell curve, the formation that works best for this team is the 4-3-3 formation at the highest point of the bell curve. Based on the determinations of the bell curve, the control circuitry 200 and/or 228 may make recommendations to the coach of which strategy to use going forward and at what circumstances in the game.

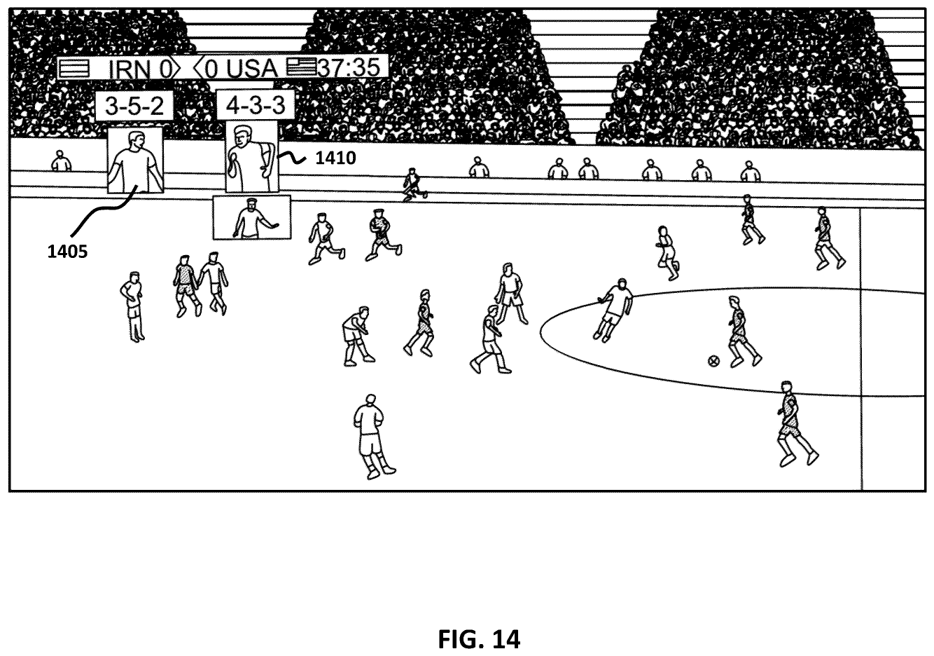

FIG. 14 is an example of one or more players in a soccer game not playing in their identified offense location, in accordance with some embodiments of the disclosure.

In some embodiments, as the game progresses, any changes to the formation may be computed by the control circuitry 200 and/or 228 with respect to a player's location, such as with respect to a zone or with respect to another player. The control circuitry 200 and/or 228 may also automatically highlight or display images of a player that violates an identified formation. For example, as depicted at 1405, an image of the player that violates the 3-5-2 formation (e.g., the identified formation which may be predetermined, such as by the coaching team) may be displayed as an overlay on the user interface and likewise a player from the opposing team that violates the 4-3-3 formation may be depicted at 1410. Any updates to the formation may also be updated by the control circuitry 200 and/or 228 in real time (barring any network latency delays) on the user interfaces of the electronic devices. The control circuitry 200 and/or 228 may also augment the video stream to indicate the current formation, predict an upcoming formation based on player movement, and identify player breaches. The control circuitry 200 and/or 228 may also collect statistics on various formations detected that the team has been fitting during the game and show a percentage/bell curve (as depicted in FIG. 13) of how prevalent each formation has been during a game.

FIG. 15 is an example of a defending team formation line having been breached by the attacking team due to one of the defending players not sticking to the identified position or formation they have been given, in accordance with some embodiments of the disclosure. In some embodiments, FIG. 15 shows an augmentation of a first virtual/augmented line 1510 and a second virtual/augmented line 1520. The first virtual/augmented line represents players that are on team A and in a 4-3-3 offensive attack formation. The second virtual/augmented line represents players that are on team B that are defending the opposing team and as such need to defend the first four players on a one-on-one basis. As depicted, in one embodiment, player 1540, who is part of team A and on the offensive attack, may have bypassed player 1530 who is supposed to guard player 1540 on a one-on-one defense by being in front of them on the side closer to the goal, i.e., in between player 1540 and the goal. However, as depicted in FIG. 15, player 1540 bypassed player 1530 and is now in a position to have a clear, open shot towards the goal or be in a position to accept a pass from a member of the team. As such, player 1530 has breached their defensive formation by not guarding player 1540 well enough to prevent them from bypassing them in the direction of the goal. When such a breach occurs, the control circuitry 200 and/or 228 may alert the coaching team and provide updates and recommendations as suggested in block 108 of FIG. 1.

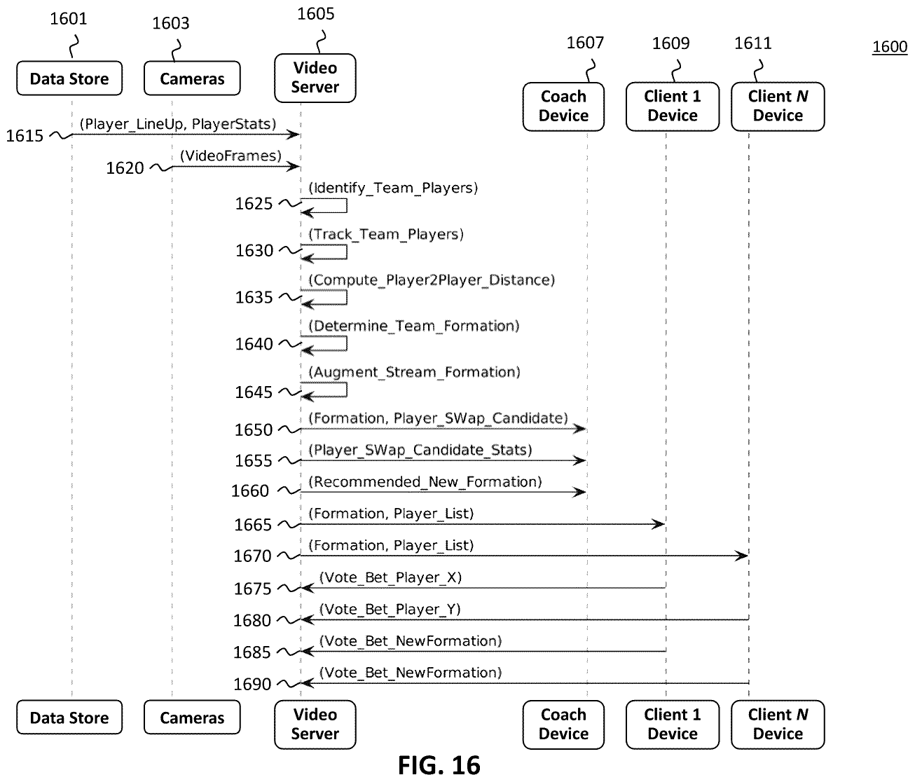

FIG. 16 is a flowchart of communication process 1600 between components of a system for implementing various player and team suggestions and providing a betting platform, in accordance with some embodiments of the disclosure.

The process 1600 may be implemented, in whole or in part, by systems or devices such as those shown in FIGS. 2-3. One or more actions of the process 1600 may be incorporated into or combined with one or more actions of any other process or embodiments described herein. The process 1600 may be saved to a memory or storage (e.g., any one of those depicted in FIGS. 2-3) as one or more instructions or routines that may be executed by a corresponding device or system to implement the method 1600.

In some embodiments, the components used in the communication process 1600 may include a data store 1601, cameras 1603, video server 1605, coach device 1607, client 1 device 1609, and client N device 1611.

In some embodiments, at block 1615, the data store 1601 may provide the video server 1605 information relating to the player, the lineup or formation, and the player statistics. This information may include a roster of the team, player positions within the team, and player statistics. Some examples of player statistics include number of goals or assists for each player if the game relates to a soccer match, touchdown scores or sacks made if the game relates to an American football game, or free throws made and shooting percentage if the game relates to a basketball game. Examples of a player roster and player statistics are provided in FIGS. 9 and 12.

In some embodiments, one of cameras 1603 may send video frames 1620 to the video server 1605. As described earlier, a plurality of camera video feeds may be available, and the control circuitry 200 and/or 228 may select one or more camera video feeds that are relevant to the player or the team that is being monitored. Video frames 1620 relating to the selected video feed may be sent to the video server 1605.

Once the player information 1615 and video frame 1620 are received by the video server 1605, the video server may then identify the team players at 1625. The video server 1605 may then track the team players at 1630, such as the team players of interest.

In some embodiments, the video server 1605 may then compute player-to-player distance at 1635 to determine team formation 1640. In other embodiments, the video server 1605 make compute the current location of a player with respect to an identified or predetermined location on the field of play. In yet another embodiment the video server 1605 may compute a current location of the player with respect to a player from the opposing team.

Based on the calculations made, the video server made determine that team's formation at 1640. The video server may then augment the video stream at 1645 with that team formation determined at 1640. For example, if a determination is made that the team formation is currently an offense formation of a 4-3-3 in a soccer game, then the augmentation may be performed by displaying on a user interface a virtual line representing the 4-3-3 formation in a soccer game.

At 1650, the video server may suggest a swap/substitution for the current player to the coaching device 1607. The video server 1605 may also provide statistics relating to the player who is being swapped and to the player who is recommended to be swapped with the current player at 1655. The videos server may also recommend new team formations at 1660. Similarly, the video server 1605 may also provide information relating to the team formation, player list, and substitution to client devices 1-N 1609, 1611 at 1665 and 1670. In some embodiments, the information, suggestions, and statistics provided to the coaching device may be different from the information, suggestions and system statistics provided to client devices 1-N. This may be because the use case for a coach in utilizing that information may be different than a use case for a client or fan device. For example, the coach may utilize such information to make coaching changes and decisions while the game is in play. As such, in some embodiments, the information provided to the coach may include data that is private and confidential to the team and may include certain team strategies that are not to be shared publicly. On the other hand, in some embodiments, a fan device may use the information for tracking their favorite player or betting for or against a player or a team or use it to rate a type of play on the field of play, rate a player, rate a coach, or rate a substitution.

In some embodiments, the client devices may vote on a player X or a player Y or on a new team formation at blocks 1675-1690, such as based on the information and statistics provided by the video server 1605. The client devices may also bet on any part of the game or any aspect of a player or a coach's performance using their client devices.

It will be apparent to those of ordinary skill in the art that methods involved in the above-described embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
analyzing, by a first computing device, a video of a sports event that includes a plurality of players from a first team and a second team on a field of play;
determining, based on the analysis, whether the first team is currently playing offense or defense;
identifying a formation based on determining whether the first team is currently playing offense or defense, wherein the identified formation is associated with locations of players from the first team in one or more zones of the field of play;
determining, based on monitoring a first player from the first team, a current location of the first player within the one or more zones of the field of play;
calculating a vector for the first player, wherein the calculated vector represents a distance from the current location of the first player to a particular location of the first player associated with the identified formation; and
updating a user interface based on the calculated vector.

2. The method of claim 1, further comprising:
determining, based on the calculated vector, that the distance from the current location of the first player to the particular location of the first player exceeds a distance threshold; and
in response to determining that the distance from the current location of the first player to the particular location of the first player exceeds the distance threshold, executing an action to perform any one or more of:
a) transmitting an alert to a second computing device, wherein the alert provides information that the first player has exceeded the distance threshold;
b) associating negative score or ratings for the first player;
c) visually distinguishing the first player on a user interface of the second computing device from other players from the first team; or
d) transmitting a substitution alert to the second computing device, wherein the substitution alert provides information to substitute the first player with another player from the first team.

3. The method of claim 1, further comprising:
determining, based on the calculated vector, that the distance from the current location of the first player to the particular location of the first player is within a distance threshold; and
in response to determining that the distance from the current location of the first player to the particular location of the first player is within the distance threshold, executing an action to perform any one or more of:
a) associating positive score or ratings for the first player;
b) transmitting an alert to a second computing device, wherein the alert provides information to continue playing the first player in their current position; or
c) visually distinguishing the first player on the user interface of the second computing device from other players from the first team.

4. The method of claim 1, further comprising:
determining, based on the calculated vector, that the distance from the current location of the first player to the particular location of the first player exceeds a distance threshold;
determining whether an exception applies to the first player, based on a current circumstance on the field of play, that permits the first player to exceed the distance threshold; and
in response to determining that the exception applies to the first player, associating positive score or ratings for the first player and in response to determining that the exception does not apply to the first player, associating negative score or ratings for the first player.

5. The method of claim 4, wherein the exception includes any one of:
a) the first player being in possession of a ball used in the sports event;
b) the first player being in a position to score in the sports event;
c) a player from the second team defending the first player by being within a particular distance from the first player; or
d) the first player exceeding the particular distance threshold for a time period that is lesser than an identified time threshold.

6. The method of claim 1, further comprising:
monitoring movement of the players from the first team;
determining, based on the monitoring, that the players from the first team have moved from a previous location to a second location on the field of play;
performing a shape analysis based on the determined second location of the players from the first team; and
updating a formation strategy on the user interface of a second computing device to reflect results from the second shape analysis.

7. The method of claim 6, further comprising:
determining the identified formation based on the shape analysis; and
displaying the identified formation on the user interface, wherein the displaying comprises outlining the identified formation.

8. The method of claim 1, further comprising, displaying a notification on the user interface, wherein the notification includes a recommendation to substitute the first player with another player from the first team, wherein the recommendation to substitute is based on the first player not following the identified formation.

9. The method of claim 1, further comprising:
generating a first matrix of coordinates based on identified locations of the players from the first team;
generating a second matrix of coordinates based on current locations of the players from the first team; and
calculating distance vectors for each player from the first team by comparing the coordinates of the first matrix with the coordinates of the second matrix.

10. The method of claim 1, further comprising:
receiving a plurality of videos captured at different angles of the sports event; and
selecting a video, from the plurality of videos, that captures a desired zone, from the one or more zones of the field of play, wherein the desired zone is selected based on a player from the first team that is to be monitored being present in the desired zone.

11. The method of claim 1, further comprising, providing a platform for betting on one or more of performance of a player from the first or second team, performance of a coach associated with the first or second team, or formations played by the first or second team.

12. A system comprising:
communications circuitry configured to access a first computing device; and
control circuitry configured to:
analyze a video of a sports event that includes a plurality of players from a first team and a second team on a field of play;
determine, based on the analysis, whether the first team is currently playing offense or defense;
identify a formation based on determining whether the first team is currently playing offense or defense, wherein the identified formation is associated with locations of players from the first team in one or more zones of the field of play;
determine, based on monitoring a first player from the first team, a current location of the first player within the one or more zones of the field of play;
calculate a vector for the first player, wherein the calculated vector represents a distance from the current location of the first player to a particular location of the first player associated with the identified formation; and
updating a user interface of the first computing device based on the calculated vector.

13. The system of claim 12, further comprising, the control circuitry configured to:
determine, based on the calculated vector, that the distance from the current location of the first player to the particular location of the first player exceeds a distance threshold; and
in response to determining that the distance from the current location of the first player to the particular location of the first player exceeds the distance threshold, execute an action to perform any one or more of:
a) transmitting an alert to a second computing device, wherein the alert provides information that the first player has exceeded the distance threshold;
b) associating negative score or ratings for the first player;
c) visually distinguishing the first player on a user interface of the second computing device from other players from the first team; or
d) transmitting a substitution alert to the second computing device, wherein the substitution alert provides information to substitute the first player with another player from the first team.

14. The system of claim 12, further comprising, the control circuitry configured to:
determine, based on the calculated vector, that the distance from the current location of the first player to the particular location of the first player is within a distance threshold; and
in response to determining that the distance from the current location of the first player to the particular location of the first player is within the distance threshold, execute an action to perform any one or more of:
a) associating positive score or ratings for the first player;
b) transmitting an alert to a second computing device, wherein the alert provides information to continue playing the first player in their current position; or
c) visually distinguishing the first player on the user interface of the second computing device from other players from the first team.

15. The system of claim 12, further comprising, the control circuitry configured to:
determine, based on the calculated vector, that the distance from the current location of the first player to the particular location of the first player exceeds a distance threshold;
determine whether an exception applies to the first player, based on a current circumstance on the field of play, that permits the first player to exceed the distance threshold; and
in response to determining that the exception applies to the first player, associating positive score or ratings for the first player and in response to determining that the exception does not apply to the first player, associate negative score or ratings for the first player.

16. The system of claim 15, wherein the exception includes any one of:
a) the first player being in possession of a ball used in the sports event;
b) the first player being in a position to score in the sports event;
c) a player from the second team defending the first player by being within a particular distance from the first player; or
d) the first player exceeding the particular distance threshold for a time period that is lesser than an identified time threshold.

17. The system of claim 12, further comprising, the control circuitry configured to:
monitor movement of the players from the first team;
determine, based on the monitoring, that the players from the first team have moved from a previous location to a second location on the field of play;
perform a shape analysis based on the determined second location of the players from the first team; and
update a formation strategy on the user interface of a second computing device to reflect results from the second shape analysis.

18. The system of claim 12, further comprising, the control circuitry configured to display a notification on the user interface, wherein the notification includes a recommendation to substitute the first player with another player from the first team, wherein the recommendation to substitute is based on the first player not following the identified formation.

19. The system of claim 12, further comprising, the control circuitry configured to:
receive a plurality of videos captured at different angles of the sports event; and
select a video, from the plurality of videos, that captures a desired zone, from the one or more zones of the field of play, wherein the desired zone is selected based on a player from the first team that is to be monitored being present in the desired zone.

20. The system of claim 12, further comprising, the control circuitry configured to provide a platform for betting on one or more of performance of a player from the first or second team, performance of a coach associated with the first or second team, or formations played by the first or second team.
